(19) United States
(12) Patent Application Publication
(10) Pub. No.: US 2025/0340135 A1
(43) Pub. Date: Nov. 6, 2025

(54) TRANSFER LINE AND CABLE ROUTING FOR HYDROGEN POWERED REFUSE VEHICLE

(71) Applicant: Oshkosh Corporation, Oshkosh, WI (US)

(72) Inventor: Chad Smith, Omro, WI (US)

(73) Assignee: Oshkosh Corporation, Oshkosh, WI (US)

(21) Appl. No.: 19/197,757

(22) Filed: May 2, 2025

Related U.S. Application Data
(60) Provisional application No. 63/642,170, filed on May 3, 2024.
(60) Provisional application No. 63/642,070, filed on May 3, 2024.

(51) Int. Cl. B60L 50/75; B60K 1/04; B60K 15/03; B60L 1/00

(52) U.S. Cl. CPC B60L 50/75; B60K 1/04; B60K 15/03; B60L 1/003; B60K 2015/03315; B60L 2200/40

(57) ABSTRACT

A refuse vehicle includes a chassis and a body defining a refuse compartment. The body is coupled to the chassis. The refuse vehicle further includes a fuel storage tank coupled to the body, a battery coupled to the body, and a hydrogen fuel cell coupled to the chassis. The refuse vehicle further includes a battery cable coupling the battery to the hydrogen fuel cell and a fuel conduit coupling the fuel tank to the hydrogen fuel cell.

### CROSS-REFERENCE TO RELATED PATENT APPLICATIONS

This application claims the benefit of and priority to U.S. Provisional Application No. 63/642,170, filed May 3, 2024, and U.S. Provisional Patent Application No. 63/642,070, filed May 3, 2024, the entire disclosures of each of which are incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle comprising a chassis, a body defining a refuse compartment, the body coupled to the chassis, a fuel tank coupled to the body, a battery coupled to the body, a hydrogen fuel cell coupled to the chassis, a battery cable coupling the battery to the hydrogen fuel cell, and a fuel conduit coupling the fuel tank to the hydrogen fuel cell.

Another embodiment relates to a refuse vehicle comprising a chassis, a body coupled to the chassis, a fuel tank coupled to the body, a battery coupled to the body, a hydrogen fuel cell coupled to the chassis, a fuel conduit coupled to the fuel tank, and a battery cable coupled to the battery. The fuel conduit extends along a first side of the body and the battery cable couples to the battery and extends along a second side of the body. The second side of the body is opposite the first side of the body.

Another embodiment relates to a vehicle comprising a chassis, a body coupled to the chassis, a fuel tank coupled to the body, a battery coupled to the body, a hydrogen fuel cell coupled to the chassis, a fuel conduit coupled to the fuel tank and the hydrogen fuel cell, and a battery cable coupled to the battery pack and the hydrogen fuel cell. The fuel conduit is configured to deliver hydrogen from the fuel tank to the hydrogen fuel cell and battery cable is coupled to the battery and the hydrogen fuel cell. The battery cable is configured to deliver electricity from the hydrogen fuel cell to the battery. The fuel conduit extends along a first side of the body and the battery cable extends along a second side of the body. The first side of the body is opposite the first side of the body.

Another embodiment relates to a refuse vehicle comprising a chassis, a body assembly, a hydrogen generation system supported by the chassis, and a power system coupled with the hydrogen generation system. The body assembly is coupled to the chassis and defines a refuse compartment for storing refuse therein. The hydrogen generation system is configured to supply hydrogen to the power system. The power system is configured to provide energy generated using the hydrogen received from the hydrogen generation system to perform at least one of a driving operation or a body operation of the refuse vehicle.

In one aspect, which is combinable with any of the above embodiments, the hydrogen generation system includes a fluid supply configured to store a fluid, a hydrogen generation component fluidly coupled with the fluid supply, and a supply conduit configured to fluidly couple the hydrogen generation component with the power system. The fluid includes a hydrogen donor compound. The hydrogen generation component is configured to receive the fluid from the fluid supply and perform, using the fluid, a hydrogen generation process to generate hydrogen to be supplied to the power system via the supply conduit.

In one aspect, which is combinable with any of the above embodiments and aspects, the fluid is water and the hydrogen generation process performed by the hydrogen generation component is an electrolysis process.

In one aspect, which is combinable with any of the above embodiments and aspects, the fluid is methane and the hydrogen generation process performed by the hydrogen generation component is a methane pyrolysis process or a hydrocarbon reforming process.

In one aspect, which is combinable with any of the above embodiments and aspects, the hydrogen generation system is configured to receive electrical energy to perform the hydrogen generation process from at least one of (i) a battery of the refuse vehicle, (ii) an external power source, (iii) a brake system of the refuse vehicle, or (iv) an energy clipping process including receiving electrical energy from a component of the refuse vehicle outputting more energy than is used by the component.

In one aspect, which is combinable with any of the above embodiments and aspects, the power system includes at least one of a hydrogen internal combustion engine or a hydrogen fuel cell.

In one aspect, which is combinable with any of the above embodiments and aspects, the hydrogen generation system further includes a hydrogen reservoir configured to store the hydrogen generated by the hydrogen generation component.

In one aspect, which is combinable with any of the above embodiments and aspects, the refuse vehicle further comprises a plurality of tractive elements. The driving operating includes driving one or more of the plurality of tractive elements using energy provided by the power system.

In one aspect, which is combinable with any of the above embodiments and aspects, the refuse vehicle further comprises a plurality of hydraulically-powered components. The body operation includes powering one or more of the plurality of hydraulically-powered components using energy provided by the power system.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a first-side view of a refuse vehicle, including a body and a chassis, according to some embodiments;

FIG. 2 is a perspective view of a refuse vehicle, according to some embodiments;

FIG. 3 is a block diagram of an E-PTO System, according to some embodiments;

FIG. 4 is a first-side cross-sectional view of a refuse vehicle, according to some embodiments;

FIG. 5 is a left-side cross-sectional view of the refuse vehicle of FIG. 4, according to some embodiments;

FIG. 6 is a side view of the refuse vehicle of FIG. 1 with a body lifted relative to the chassis, according to some embodiments;

FIG. 7 is a detailed side view of a refuse vehicle, according to some embodiments;

FIG. 8 is a first side cross-sectional view of a refuse vehicle, including a fuel line, where the body is supported by the chassis in a first position, according to some embodiments;

FIG. 9 is a first side cross sectional view of the refuse vehicle of FIG. 8 where the body is lifted is relative to the chassis in a second position, according to some embodiments;

FIG. 10 is a second side cross sectional view of the refuse vehicle of FIG. 8, including a battery cable, where the body in the first position, the second side opposite the first side, according to some embodiments;

FIG. 11 is a second side cross sectional view of the refuse vehicle of FIG. 8 in the second position, according to some embodiments;

FIG. 12 is another first side cross sectional view of a refuse vehicle, including a fuel line, where the body is supported by the chassis in a first position, according to some embodiments;

FIG. 13 a first side cross sectional view of the refuse vehicle of FIG. 12 where the body is lifted is relative to the chassis in a second position, according to some embodiments;

FIG. 14 is a second side cross sectional view of the refuse vehicle of FIG. 12 in the first position according to some embodiments;

FIG. 15 a second side cross sectional view of the refuse vehicle of FIG. 12, including a battery cable, where the body is in the second position, according to some embodiments;

FIG. 16 is a first side cross sectional view of a refuse vehicle, including a fuel line, where the body is supported by the chassis in a first position, according to some embodiments;

FIG. 17 is a first side cross sectional view of the refuse vehicle of FIG. 16 where the body is lifted is relative to the chassis in a second position, according to some embodiments;

FIG. 18 is a second side cross sectional view of the refuse vehicle of FIG. 16, including a battery cable, where the body is in the first position, the second side opposite the first side, according to some embodiments;

FIG. 19 is a second side cross sectional view of the refuse vehicle of FIG. 16 in the second position, according to some embodiments;

FIG. 20 is a top view of the refuse vehicles of FIGS. 8, 12, and 16 according to some embodiments;

FIG. 21 is another top view of the refuse vehicles of FIGS. 8, 12, and 16, according to some embodiments;

FIG. 22 is a first side cross sectional view of a refuse vehicle, including a fuel line, where the body is supported by the chassis in a first position, according to some embodiments;

FIG. 23 is a first side cross sectional view of the refuse vehicle of FIG. 22 where the body is lifted is relative to the chassis in a second position, according to some embodiments;

FIG. 24 is a second side cross sectional view of the refuse vehicle of FIG. 22, including a battery cable, where the body is in the first position, the second side opposite the first side, according to some embodiments;

FIG. 25 is a second side cross sectional view of the refuse vehicle of FIG. 22 in the second position, according to some embodiments;

FIG. 26 is a top view of the refuse vehicle of FIG. 22, according to some embodiments;

FIG. 27 is another top view of the refuse vehicle of FIG. 22, according to some embodiments;

FIG. 28 is a first side cross sectional view of a refuse vehicle, including a fuel line, where the body is supported by the chassis in a first position, according to some embodiments;

FIG. 29 is a first side cross sectional view of the refuse vehicle of FIG. 28 where the body is lifted is relative to the chassis in a second position, according to some embodiments;

FIG. 30 is a second side cross sectional view of the refuse vehicle of FIG. 28, including a battery cable, where the body is in the first position, the second side opposite the first side, according to some embodiments;

FIG. 31 is a second side cross sectional view of the refuse vehicle of FIG. 28 in the second position, according to some embodiments;

FIG. 32 is a top view of the refuse vehicle of FIG. 28, according to some embodiments;

FIG. 33 is a rear view of pivots of a refuse vehicle, according to some embodiments;

FIG. 34 is another rear view of pivots of a refuse vehicle, according to some embodiments;

FIG. 35 is a perspective view of a refuse vehicle including a hydrogen system, according to an exemplary embodiment;

FIG. 36 is a block diagram of the hydrogen system of FIG. 35, according to an exemplary embodiment;

FIG. 37 is a block diagram of the refuse vehicle of FIG. 35 including a hydrogen fuel cell, according to an exemplary embodiment; and

FIG. 38 is a block diagram of the refuse vehicle of FIG. 35 including a hydrogen internal combustion engine, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

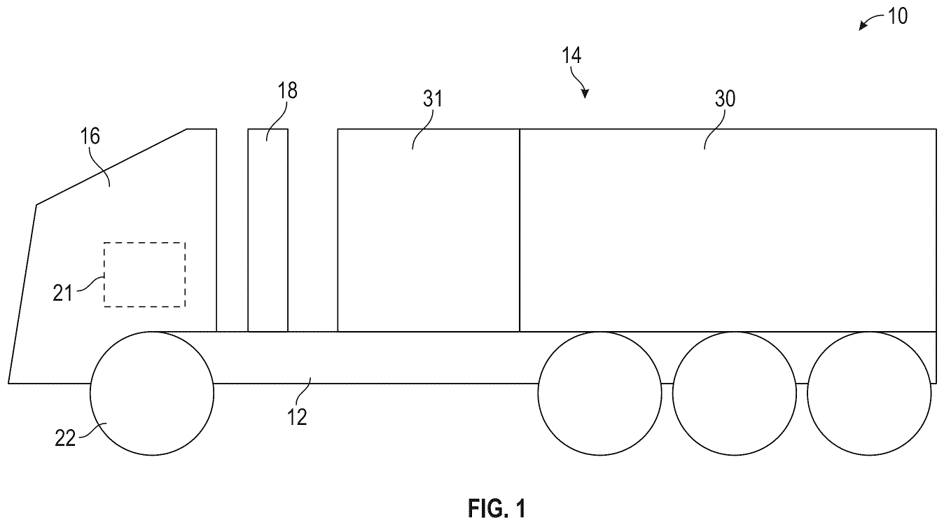

Referring generally to at least FIGS. 1-34, an electrical and fuel routing system for a hydrogen powered refuse vehicle is shown, according to various exemplary embodiments. A body of the refuse vehicle is supported by a chassis of the refuse vehicle. According to an exemplary embodiment, the electrical and fuel routing system includes a fuel cell that is coupled to a fuel tank on the body by a fuel cable. In some embodiments, the fuel tank is supported by a top of the body and is configured to provide hydrogen to the fuel cell.

In some embodiments, the fuel cell is configured to produce electricity and provide electricity to a battery assembly of the refuse vehicle that is supported on the top of the body, which may include or form part of a module that also supports the hydrogen fuel tank. The body of the refuse vehicle includes electrical components that receive power from the battery assembly. The electrical and fuel routing system also includes a battery cable that electrically couples the battery assembly to the body to provide power to the electrical components of the body and/or electrically couple the battery assembly to the chassis to provide power to the electrical components of the chassis. The body may be lifted by a service lift coupled to the body and supported by the chassis between a first position and a second position. Over time, as the vehicle operates, the hydrogen may leak, and the system may become more sensitive to electrical hazards that increase the ignition of the hydrogen gas. The electrical and fuel routing systems of the present disclosure mitigates this issue by positioning the battery cable and the fuel cable on opposite sides of the vehicle, such that the electrical and gas interconnects are spaced apart from one another at least by the body. The electrical and fuel routing systems of the present disclosure may also be more advantageous than other systems due to providing flexible portions of the battery cable and the fuel cable around pivot points of the vehicle and hard nonflexible portions of the battery cable and the fuel cable around non-pivot portions of the vehicle. The flexible portions of the battery cable and the fuel cable enable bending, stretching, and contorting when the body 14 transitions between different working states. To allow for alternate arrangements and assemblies of the chassis, the body, the fuel tank, and the battery assembly, the present disclosure also provides a chassis terminal and a body terminal for each of the fuel cable and the battery cable. Systems and methods for providing such a fuel cable and a battery cable are also described herein.

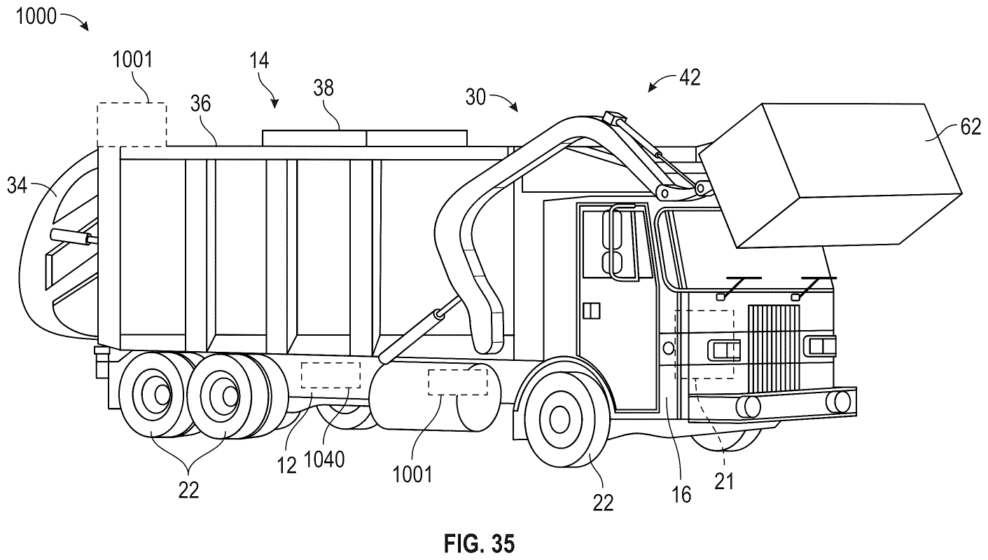

Referring generally to FIGS. 35-38, another aspect relates to a hydrogen system for a refuse vehicle, including a hydrogen generation system and a hydrogen power system. The hydrogen power system is coupled to the hydrogen generation system. The hydrogen generation system is configured to generate hydrogen (e.g., H₂, hydrogen gas, hydrogen liquid, etc.) and power one or more components of a vehicle (e.g., a refuse vehicle) using the generated hydrogen as fuel. The hydrogen system may utilize a hydrogen internal combustion engine and/or a hydrogen fuel cell to use the generated hydrogen to generate power. More specifically, the hydrogen generation system is configured to receive a hydrogen donor fluid such as water (e.g., H₂O, steam, water vapor, liquid water, etc.), a hydrocarbon (e.g., methane (CH₄), etc.), or another suitable hydrogen donor fluid (e.g., alcohols, hydrides, etc.). The hydrogen generation system is supplied with energy (e.g., electric energy) to perform a hydrogen generation process (e.g., water splitting such as electrolysis, hydrocarbon reforming such as steam reforming, hydrocarbon/methane pyrolysis, etc.) using the fluid to generate hydrogen. The hydrogen is then supplied to the hydrogen power system and used as fuel such that the hydrogen power system generates energy to power one or more components of the vehicle. The hydrogen power system may operate alone or in combination with one or more power systems of the vehicle (e.g., an internal combustion engine, a prime mover, a battery pack, an electric motor, a hydraulic pump, etc.) to power one or more components of the vehicle.

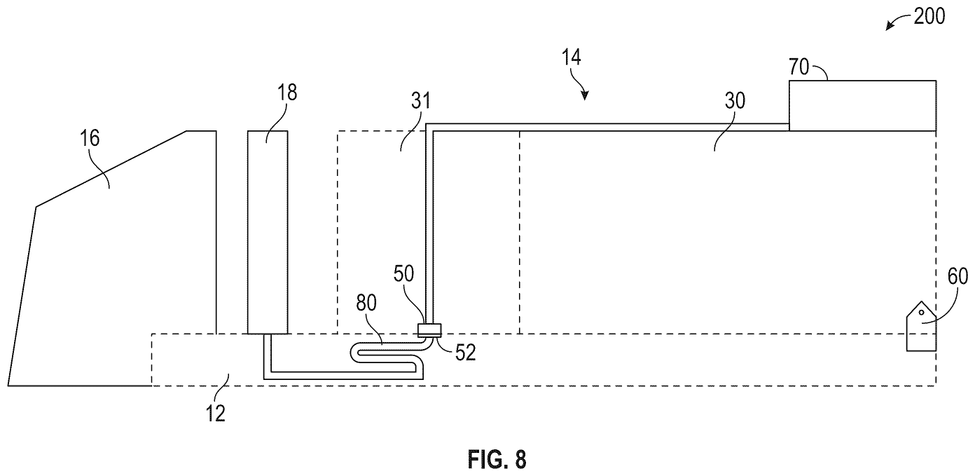

The hydrogen generation system may use excess energy received from an external power source when a battery of the vehicle has reached or is approaching charging capacity and no longer capable of receiving energy to charge the battery. The hydrogen generation system may receive energy from one or more regenerative systems of the vehicle such as a hydraulic system and/or a braking system to enable energy clipping. By way of example, when the hydraulic system releases some or all pressurized fluid, the fluid flow may be converted to another type of energy (e.g., electrical energy). In such an example, if a motor or hydraulic storage device of the hydraulic system outputs more energy than is needed by the vehicle, a capacitor may store that energy for use at a later time and/or provide that energy to the hydrogen generation system. By way of another example, the braking system may include a motor, generator, alternator, or the like configured to convert kinetic energy during braking into electrical energy to be used to power the hydrogen generation system. The hydrogen generation system may be used with any of the electrical and fuel routing system designs described with respect to FIGS. 8-34.

### Transfer Line and Cable Routing for Hydrogen Powered Refuse Vehicle

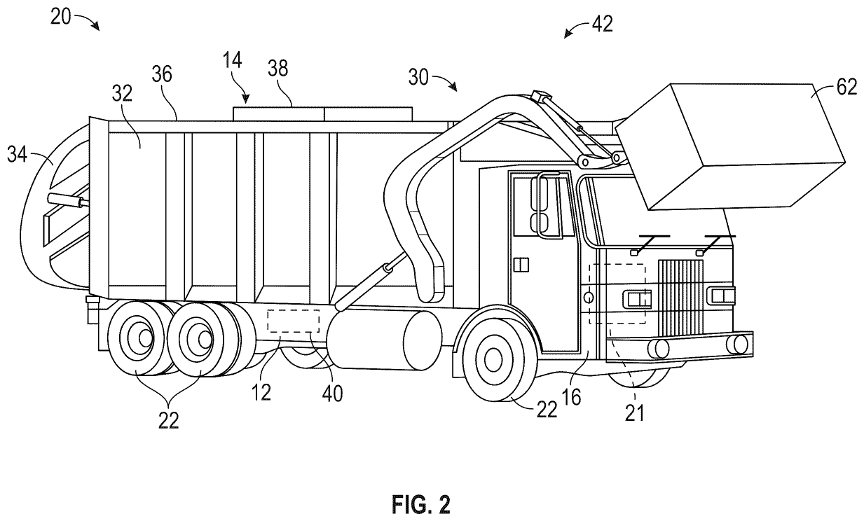

Referring now to FIG. 1, a vehicle is shown as refuse vehicle 10 (e.g., a garbage truck, a waste collection truck, a sanitation truck, a recycling truck, etc.). As shown in FIGS. 1 and 2, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.). The cab 16 may also include components that can execute commands automatically to control different subsystems within the vehicle (e.g., computers, controllers, processors, etc.). The refuse vehicle 10 further includes a power system, shown as prime mover 21, coupled to the frame 12 at a position beneath the cab 16. The prime mover 21 provides power to a plurality of motive members (e.g., tractive elements), shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 21 may be configured to use a variety of fuels (e.g., gasoline, diesel, biodiesel, ethanol, natural gas, hydrogen gas, hydrogen liquid, etc.), according to various exemplary embodiments. According to an alternative embodiment, the prime mover 21 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, the generation system 70, etc.), or from an external power source (e.g., overhead power lines) and provide power to the systems of the refuse vehicle 10. According to some embodiments, the refuse vehicle 10 may be in other configurations than shown in FIG. 1.

In some embodiments, as shown in FIG. 1, the vehicle 10 includes a fuel cell 18 (e.g., hydrogen fuel cell, etc.) located on a portion of the chassis 12 opposite a rear portion of the body 14. In other embodiments, the prime mover is or includes an internal combustion engine. According to the exemplary embodiment shown in FIG. 1, the fuel cell 18 is coupled to the frame 12 at a position behind the cab 16. In other embodiments, the fuel cell 18 is otherwise positioned and/or the refuse vehicle 10 includes a plurality of fuel cells. In still other embodiments, an electric motor is coupled to and configured to drive a hydraulic system that powers hydraulic actuators.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 may be a refuse compartment or include an on-board refused container and include a collection chamber (e.g., hopper, etc.). Loose refuse may be placed into the body 14 where it may thereafter be compacted (e.g., by a packer system, etc.). Thus, in some embodiments, the body may define a hopper volume 31 and storage volume 30 (e.g., refuse department, storage compartment, etc.). In this regard, refuse may be initially loaded into the hopper volume 31 and later compacted into the storage volume 30. The storage volume 30 may provide temporary storage for refuse during transport to a waste disposal site and/or a recycling facility. In some embodiments, at least a portion of the body 14 and the storage volume 30 extend above or in front of the cab 16. According to the embodiment shown in FIG. 1, the body 14, including the storage volume 30, is positioned behind the cab 16. As shown, the hopper volume 31 is positioned between the storage volume 30 and the cab 16 (e.g., refuse is loaded into a portion of the body 14 behind the cab 16 and stored in a portion toward the front of the body 14). In such arrangements, the refuse vehicle 10 may be a front-loading refuse vehicle or a side-loading refuse vehicle. In other embodiments, the storage volume 30 is be positioned between the hopper volume 31 and the cab 16. In such embodiments, the refuse vehicle 10 may be a rear-loading refuse vehicle in which refuse is loaded into the vehicle through a tailgate or rear end of the vehicle.

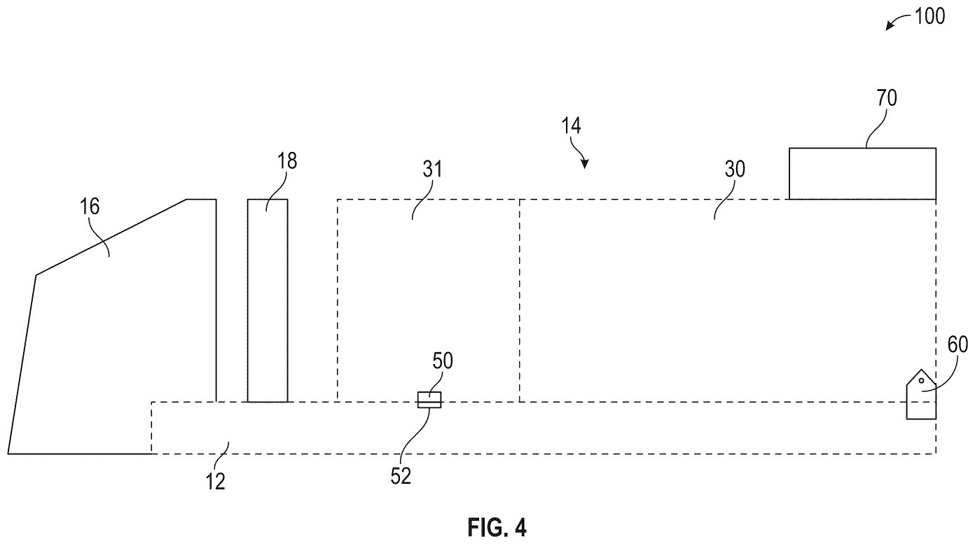

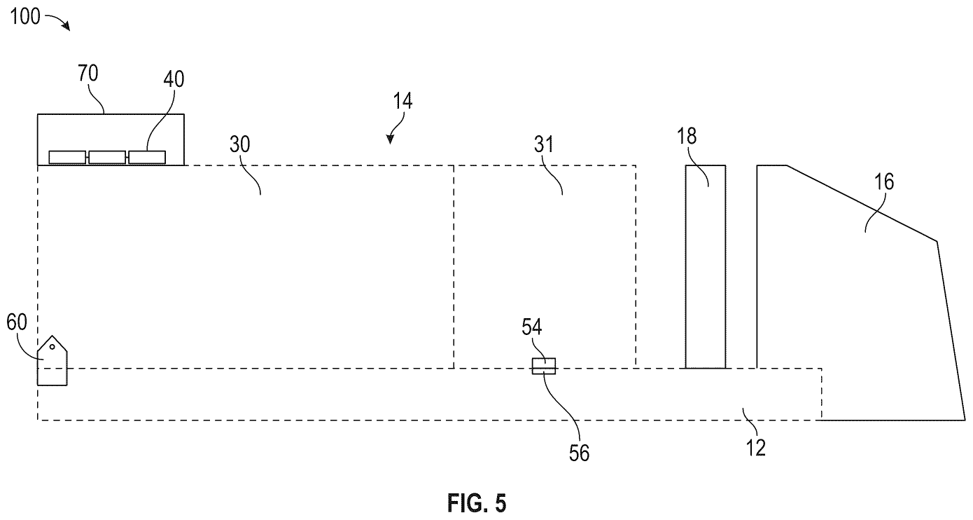

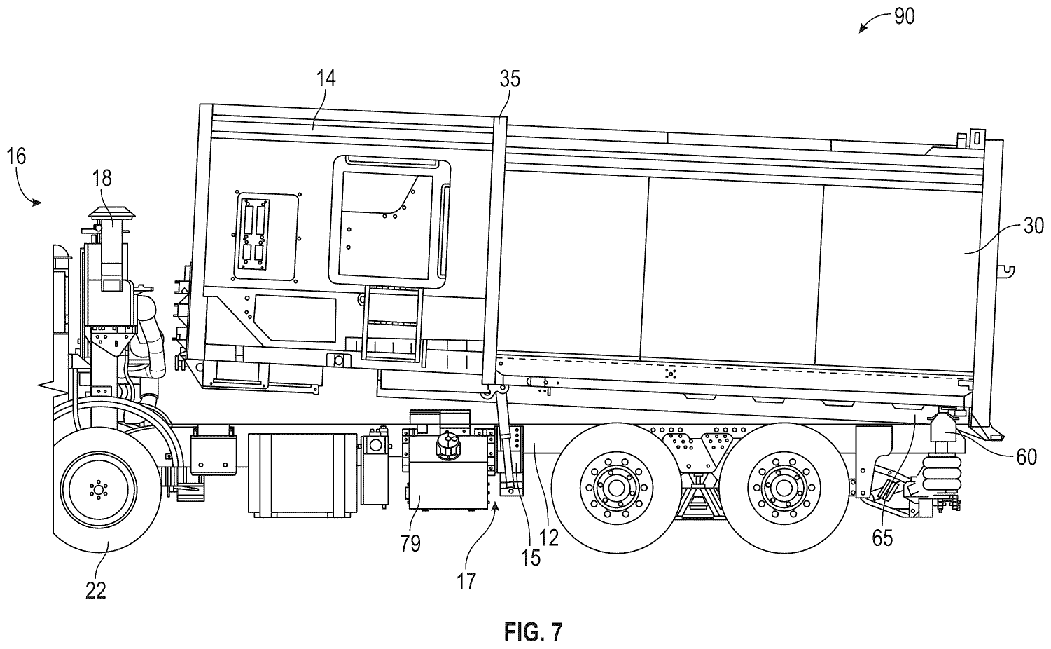

In some embodiments, the frame 12 acts as a storage portion that includes one or more vehicle components. In some embodiments, the frame 12 includes an enclosure that contains one or more vehicle components and/or a frame that supports one or more vehicle components. By way of example, the frame 12 may contain or include one or more electrical storage devices (e.g., batteries, capacitors, etc.) and hydrogen tanks as depicted in greater detail below with reference to FIGS. 4 and 5. By way of another example, the frame 12 may include fuel tanks. By way of another example, the frame 12 may include a hydraulic tank, as depicted in greater detail below with reference to FIG. 7.

Referring to FIG. 2, a view of a vehicle is shown as refuse vehicle 20 (e.g., a garbage truck, a waste collection truck, a sanitation truck, a recycling truck, etc.), according to some embodiments. The body 14 includes a plurality of panels, shown as panels 32, a tailgate 34, and a cover 36 that together define a collection chamber. The tailgate 34 is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism is used to support the tailgate 34 on the body 14.

The refuse vehicle 20 includes a lift mechanism/system (e.g., a front-loading lift assembly, etc.), shown as lift assembly 42, coupled to the front end of the body 14. In other embodiments, the lift assembly 42 extends rearward of the body 14 (e.g., a rear-loading refuse vehicle, etc.). In still other embodiments, the lift assembly 42 extends from a side of the body 14 (e.g., a side-loading refuse vehicle, etc.). As shown in FIG. 2, the lift assembly 42 is configured to engage a container (e.g., a residential trash receptacle, a commercial trash receptacle, a container having a robotic grabber arm, etc.), shown as refuse container 62. In some embodiments, the lift assembly 42 includes various actuators (e.g., electric actuators, hydraulic actuators, pneumatic actuators, etc.) to facilitate engaging the refuse container 62, lifting the refuse container 62, and tipping refuse out of the refuse container 62 into the hopper volume of the storage volume 30 through an opening in the cover 36 or through the tailgate 34. The lift assembly 42 may thereafter return the empty refuse container 62 to the ground. According to an exemplary embodiment, a door, shown as top door 38, is movably coupled along the cover 36 to seal the opening thereby preventing refuse from escaping the storage volume 30 (e.g., due to wind, bumps in the road, etc.).

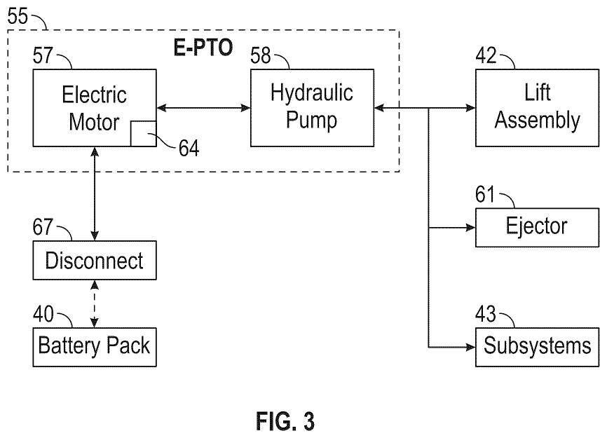

Referring to FIGS. 2 and 3, in embodiments in which the refuse vehicle 20 is an electric refuse vehicle (e.g., an E-refuse vehicle, etc.) or a hybrid refuse vehicle (e.g., a vehicle including both electric and hydraulic power systems, a vehicle including both electric and hydrogen power systems, etc.), the refuse vehicle includes an onboard energy storage device. In some embodiments, the onboard energy storage device includes one or more energy storage and/or generation system, shown as battery pack 40 (e.g., battery assembly, battery, electrical storage device, etc.) that provides power to a motor that produces rotational power to drive the refuse vehicle. The energy storage device can be used to provide power to different subsystems on the refuse vehicle.

Referring now to FIG. 3, in some embodiments the refuse vehicle also includes an electric power take-off (E-PTO) system, shown as E-PTO System 55, that is configured to receive electrical power from the battery pack 40 and/or other power sources and to convert the electrical power to hydraulic power for different subsystems 43 on the refuse vehicle. In some embodiments, the E-PTO System 55 receives electrical power from the energy storage device and provides the electrical power to an electric motor 57. In such embodiments, the electric motor 57 may drive a hydraulic pump 58 that provides pressurized hydraulic fluid to different vehicle subsystems, such as the lift assembly 42, the packer/ejector, shown as ejector 61, or other subsystems 43 (e.g., the tailgate 34, etc.).

The E-PTO system includes an E-PTO controller 64. The E-PTO controller 64 monitors various systems within the refuse vehicle, including the E-PTO System 55. The E-PTO controller 64 receives data from sensors (not shown) within the system, compares the data to expected values under normal operating conditions, adjusts the operation parameters of components of the system, and determines if a critical operating condition exists based on the sensor data. In some embodiments, the E-PTO controller 64 shuts down the system and/or the refuse vehicle in response to detecting a critical operating condition. In some embodiments, the refuse vehicle further includes a disconnect 67 positioned between the battery pack 40 and the E-PTO System 55 to allow different vehicle subsystems (e.g., the ejector 61, the lift assembly 42, etc.) to be decoupled and de-energized from the electrical power source. For example, the E-PTO controller 64 may cause the disconnect 67 to be decoupled and de-energized from the electrical power source.

Referring now to FIG. 4 a transparent first side view (e.g., a right side of the body 14, etc.) of a vehicle is shown as refuse vehicle 100 (e.g., a garbage truck, a waste collection truck, a sanitation truck, a recycling truck, etc.) in a first state, according to some embodiments. In the first state, the body 14 is substantially parallel to and supported by the frame 12. The refuse vehicle 100 includes a hydrogen generation system, shown as generation system 70 (e.g., a fuel tank, a hydrogen fuel tank, a storage tank, etc.). According to an exemplary embodiment, the generation system 70 is configured to (a) store hydrogen fuel and (b) provide hydrogen fuel at pressure to the fuel cell 18. According to illustrated embodiment of FIG. 4, the generation system 70 is coupled to and supported by the body 14 (e.g., on top of the body, coupled to the body 14 on an opposite side of the body 14 from the chassis 12, etc.). The generation system 70 is located at a rear section of the body 14 (e.g., at a rear section of the storage volume 30, a rear section of the storage volume 30, a section of the storage volume 30 opposite the chassis 12 and on an opposite side of the body from the fuel cell 18 (e.g., an opposite longitudinal end of the body, proximate to a rear end of the body, etc.). In some embodiments, the generation system 70 is accessed from the top of the body 14. Such an arrangement can improve accessibility of the generation system 70, such as from a rear of a vehicle, in addition to the sides of the vehicle. In other embodiments, the generation system 70 is otherwise positioned (e.g., within a tailgate of the refuse vehicle 100, beneath the cab 16, along the top of the body 14, within the body 14, etc.).

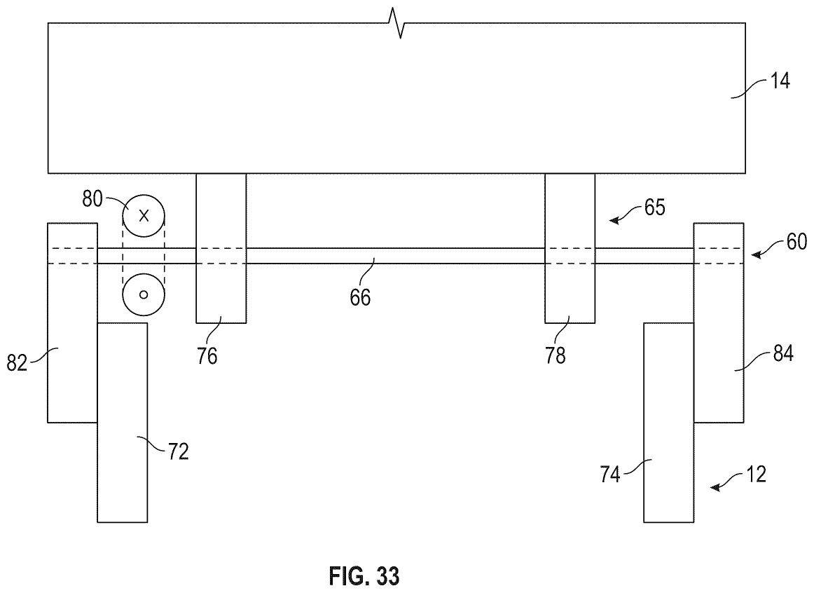

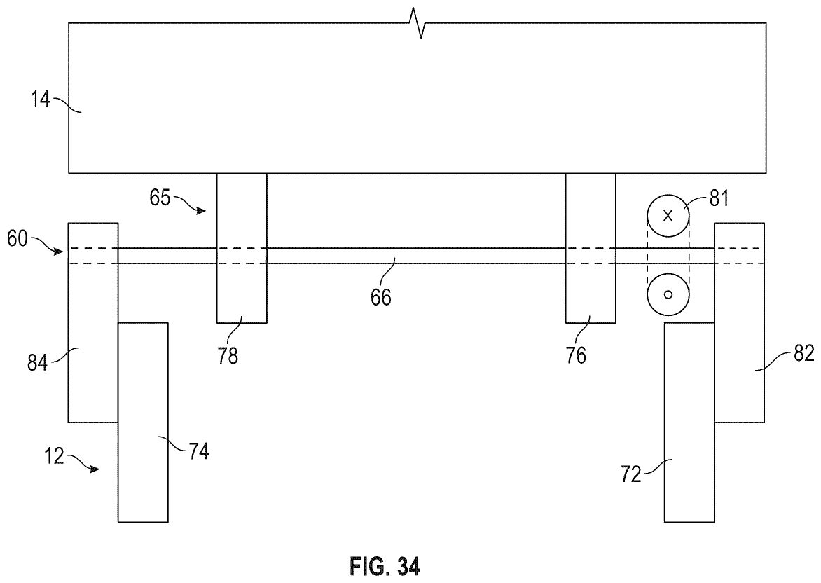

The vehicle 100 includes a bracket (depicted herein as a pivot assembly 60) configured to facilitate rotatable movement of the body 14 relative to the frame 12. The pivot assembly 60 pivotally couples the frame 12 to the body 14, such that the body 14 is rotatable relative to the frame 12 about a lateral axis formed by a crossbar, depicted in greater detail below with reference to FIGS. 33 and 34. The pivot assembly 60 is configured to facilitate free movement of the body 14 relative to the frame 12 (e.g., to facilitate lifting the body 14 to perform maintenance on components beneath the body 14, forward of the body 14, and/or within the frame 12, etc.).

The vehicle 100 includes a first body terminal 50 (e.g., a generation body terminal, a first body fluid port and/or connection, etc.) defined by the body 14 and a first chassis terminal 52 (e.g., a generation chassis terminal, a first chassis fluid port and/or connection, etc.) defined by the chassis 12. The first body terminal 50 is fluidly coupled to the generation system 70 (e.g., the first body terminal 50 is fluidly coupled to the generation system 70 by conduit, tubing, etc.). The first body terminal 50 is configured to fluidly couple to the first chassis terminal 52. For example, the vehicle 100 may include a flexible conduit (e.g., tubing) having a first end that is fluidly connected to the first body terminal 50 and a second end that is fluidly coupled to the first chassis terminal 52.

In this way, the first body terminal 50, the first chassis terminal 52, and the flexible conduit are together configured to fluidly couple the body 14 to the chassis 12 (e.g., to fluidly couple the fuel cell 18 on the chassis 12 to the generation system 70 on the body 14). The first chassis terminal 52 is fluidly coupled to the fuel cell 18 (e.g., via conduit, tubing, etc.) and is configured to provide hydrogen to the fuel cell 18 from the generation system 70.

In some embodiments, the first body terminal 50 is configured to provide hydrogen directly to components within the body 14. In some embodiments, the first chassis terminal 52 is be configured to provide hydrogen directly to components within the chassis 12. For example, an internal combustion engine may be provided on or within the body 14 or the chassis 12, and the generation system 70 may provide hydrogen for direct injection into an internal combustion engine. In some embodiments, the generation system 70 also includes a physical connection (e.g., a fuel tank port, etc.) to allow the generation system 70 to couple to an external fuel source (e.g., an external fuel tank, etc.) separately from, or in addition to, the first body terminal 50. For example, the generation system 70 may include a physical connection to allow the generation system 70 to receive fuel while the generation system 70 is also fluidly coupled to the body 14.

In some embodiments, the generation system 70 is detachably coupled to the body 14 and is removable and/or replaceable. In such embodiments, the generation system 70 can be removed and/or replaced by another generation system 70. In some embodiments, the generation system 70 is located under or alongside a portion of the body 14 that defines the storage volume 30 and is accessed by removing the body portion defining the storage volume 30. For example, a refuse vehicle with a removable refuse compartment (e.g., a container truck) may remove the refuse compartment to reveal the generation system 70.

Referring now to FIG. 5 a transparent second side view (e.g., a left-side side of the body 14, etc.) of the vehicle 100 is shown, according to some embodiments. The second side of the body 14 is opposite the first side of the body 14. As shown in FIG. 5, the refuse vehicle 100 includes the battery pack 40 (e.g., the battery assembly, etc.). According to the illustrated embodiment, the battery pack 40 is coupled to and supported by the body 14 (e.g., on top of the body, coupled to the body 14 on an opposite side of the body 14 from the chassis 12, etc.) and is located at a rear section of the body 14 (e.g., at a rear section of the storage volume 30, a rear section of the storage volume 30, a section of the storage volume 30 opposite the chassis 12 and on an opposite side of the body from the fuel cell 18, etc.). Locating the battery pack 40 on top of the body 14 simplifies access to the battery pack 40, so that a user may readily inspect and service the battery pack 40 without having to access other parts of the vehicle 100.

In some embodiments, and as shown, the battery pack 40 is located next to (e.g., is laterally offset from, etc.) the generation system 70. In other embodiments, the battery pack 40 is positioned at another location along the body 14 or the chassis 12 (e.g., within a tailgate of the refuse vehicle 100, beneath the cab 16, along the top of the body 14, within the body 14, a distance along the body 14 from the generation system 70, within the chassis 12, etc.). In some embodiments, the battery pack 40 is coupled to a side portion of the body 14. In some embodiments, the battery pack 40 is removable/detachable from the body 14.

In some embodiments, the battery pack 40 is detachably coupled to the body 14 and is removable and/or replaceable. In some embodiments, the battery pack 40 may be accessed from the top of the body 14. Similarly, in some embodiments, the battery pack 40 may be removed and/or replaced by another energy storage and/or generation system. Alternatively, in some embodiments, one or more individual battery cells of the battery pack 40 could be replaced. In some embodiments, the battery pack 40 is accessed by removing the storage volume 30. For example, a refuse vehicle with a removable refuse compartment (e.g., a container truck) may remove the refuse compartment to reveal the battery pack 40.

According to an exemplary embodiment, the battery pack 40 is configured to (a) receive, generate, and/or store power and (b) provide electric power to (i) the electric motor 57 to drive the wheels 22, (ii) electric actuators of the refuse vehicle 100 to facilitate operation thereof (e.g., lift actuators, tailgate actuators, packer actuators, grabber actuators, etc.), and/or (iii) other electrically operated accessories of the refuse vehicle 100 (e.g., displays, lights, etc.). The battery pack 40 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In some embodiments, the refuse vehicle 100 includes an internal combustion generator that utilizes one or more fuels (e.g., gasoline, diesel, propane, natural gas, hydrogen, etc.), such as the fuel cell 18 described with reference to FIGS. 4-5, to generate electricity to charge the battery pack 40, power the fuel cell 18, power the electric actuators, and/or power the other electrically operated accessories (e.g., a hybrid refuse vehicle, etc.).

For example, the refuse vehicle 100 may have an internal combustion engine augmented by the electric motor 57 to cooperatively provide power to the wheels 22. The battery pack 40 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 100. In some embodiments, the battery pack 40 includes a heat management system (e.g., liquid cooling, heat exchanger, air cooling, etc.).

In some embodiments, the battery pack 40 includes one or more attachment mechanisms (e.g., pins, linkages, latches, etc.) to couple the battery pack 40 to the frame 12. In other embodiments, and as described above, the battery pack 40 is coupled to the body 14 by the one or more attachment mechanisms. In some embodiments, the battery pack 40 is a pod or battery compartment, configured to receive and electrically couple one or more batteries. For example, the battery pack 40 may allow a battery cell to be inserted from one end thereby coupling the battery cell to the battery pack 40 and providing power to the refuse vehicle 100. In some embodiments, the battery pack 40 is modular and facilitates easy replacement of one or more battery cells. For example, a second fully charged battery cell may replace a first depleted battery cell by uncoupling the first battery cell from the battery pack 40 and replacing it with the second battery cell (e.g., separately from other battery cells within the battery pack 40). In some embodiments, the entire battery pack 40 can be replaced with a different one of battery pack 40. Replacing one or more battery cells of the battery pack 40 reduces the downtime associated with charging a typical battery system. In some embodiments, the battery pack 40 is “hot-swappable” and is able to replace one or more battery cells without cutting power to the refuse vehicle 100.

The battery pack 40 may include an electric connection (e.g., a pantograph, a current collector, a high-voltage line, etc.) to allow the battery pack 40 to connect to external power sources (e.g., an overhead power line, the grid, a charging station, etc.). For example, the battery pack 40 may include a charging port to allow one or more battery cells to be charged while the battery pack 40 is coupled to the refuse vehicle 100 (e.g., by a 220V charger). For example, the refuse vehicle 100 may include a 220V charging port on a side of the body 14 to charge the battery pack 40. In some embodiments, the battery pack 40 includes an electrical bypass to power the refuse vehicle 100 from a charging source while the battery is being charged. In some embodiments, the battery pack 40 connects to one or more power sources of refuse vehicle 100 (e.g., an internal combustion generator, the fuel cell 18, a battery, etc.) to charge the battery pack 40. For example, the battery pack 40 may include a connection to an onboard diesel generator or the fuel cell 18 configured to provide power to the battery pack 40 for charging.

Referring to FIG. 5, the vehicle 100 includes a second body terminal 54 (e.g., a battery body terminal, etc.) and a second chassis terminal 56 (e.g., a battery chassis terminal, etc.). The second body terminal 54 is disposed on the body 14 and the second chassis terminal 56 is disposed on the frame 12. The second body terminal 54 is configured to couple to the battery pack 40 (e.g., by a cable extending between the second body terminal 54 and the battery pack 40, etc.), which in turn provides electrical power to various components stored in the body 14. The second chassis terminal 56 is configured to couple to the second body terminal 54, for example, by a cable (e.g., a flexible cable, etc.), which in turn provides power to various components stored in the chassis 12. The second body terminal 54 and the second chassis terminal 56 also electrically connect the body 14 to the chassis 12. In some embodiments, the second chassis terminal 56 may be coupled to the fuel cell 18 (e.g., by a cable extends between the second chassis terminal 56 and the fuel cell 18, etc.) instead of or in addition to other components mounted to the chassis 12. For example, the fuel cell 18 may produce electricity from the hydrogen provided by the generation system 70, and the electricity may then be routed to the battery pack 40 to provide electricity to charge the battery pack 40.

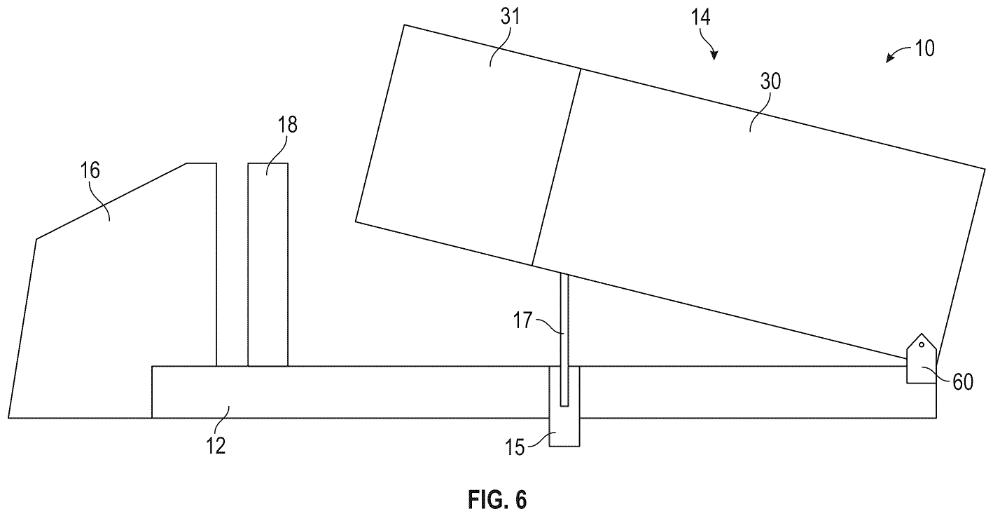

Referring now to FIG. 6, the vehicle 10 of FIG. 1 is shown with the body 14 lifted and rotated with respect to the pivot assembly 60, in a second position that is rotatably offset from the first position, by one or more hydraulic cylinders, shown as lift cylinders 17. The lift cylinders 17 are coupled to and extend between the body 14 and the frame 12. The lift cylinders 17 are positioned forward of the pivot assembly 60 and rearward of the cab 16. In some embodiments, the lift cylinders 17 can be used to apply an upward force to lift the body 14 relative to the frame 12 (e.g., when performing maintenance). In some embodiments, the lift cylinders 17 provide a damping force that opposes movement of the body 14 relative to the frame 12. The lift cylinders 17 may be rotatably coupled to lift brackets 15. The lift brackets 15 are fixedly coupled (e.g., welded, bolted, etc.) to opposite sides of the frame 12.

Referring now to FIG. 7, a more detailed depiction of a vehicle, shown as refuse vehicle 90 (e.g., a garbage truck, a waste collection truck, a sanitation truck, a recycling truck, etc.) is shown being lifted by the lift cylinders 17 is shown, according to some embodiments. As shown, the lift brackets 15 are rotatably coupled to a base 65 of the body 14. In some embodiments, the lift cylinders 17 are rotatably coupled to the base 65 of the body 14 by one or more clevises fixedly coupled to the base 65. Each of the lift cylinders 17 include a first end or frame end coupled to the frame 12, and a second end or body end, coupled to the body 14 (e.g., via the base 65 of the body 14). The frame ends of the lift cylinders 17 are coupled to the base 65 of the body 14 under, near, or on a structural member positioned towards the middle of the body 14, shown as mid-posts 35. The mid-posts 35 are positioned at a distance away from the rear end of the body 14 that is greater than the distance of a center of gravity of the body 14 from the rear end of the body 14. In some embodiments, the center of gravity of the body 14 is positioned at the mid-posts 35 or forward of the mid-posts 35. As such, much of the force generated against the body 14 during operation of the lift cylinders 17 (and thus the lifting of the body 14) is directed through the mid-posts 35 to reduce stresses within other portions of the body 14. The frame ends of the lift cylinders 17 are configured to move relative to the body end. In operation the lift cylinders 17 extend (e.g., the frame ends move away from the body ends) as the body 14 moves upward relative to the frame 12. Similarly, the lift cylinders 17 retract (e.g., the frame ends move towards the body ends) as the body 14 moves downward relative to the frame 12. Accordingly, the lift cylinders 17 can control the relative position of the body 14 and the frame 12. By way of example, if hydraulic fluid were added to a chamber within each of the lift cylinders 17 (e.g., a volume within the body ends of the lift cylinders 17), the lift cylinders would extend and raise the body 14. If hydraulic fluid were allowed to be released from the chamber within each of the lift cylinders 17, the lift cylinders 17 would retract and lower the body 14. Thus, the amount of fluid in each of the lift cylinders 17 may be varied by an operator to raise or lower the body 14.

The hydraulic fluid may be stored in one or more hydraulic tanks, shown as hydraulic tank 79 (e.g., tank, cylinder, container, vat, drum, canister, vessel, etc.). In some embodiments, and as shown, the lift cylinders 17 are positioned rearwards along the frame 12 relative to the hydraulic tank 79. In other embodiments, the lift cylinders 17 are positioned forwards along the frame 12 relative to the hydraulic tank 79. In some embodiments, the frame 12 is permitted to flex in response to varying loadings due to lifting of the body 14. In some embodiments, the lift cylinders 17 may be electrically powered actuators (e.g., electromechanical actuators) that are electrically coupled to the second body terminal 54 and powered by the battery pack 40 (e.g., a battery). For example, the electromechanical actuator may include a cylinder base that coupled to the body 14 and electrically coupled to the first body terminal 50 or the second body terminal 54. The terminal may be coupled to an underside (e.g., the bottom) of the body 14. An actuator rod may extend from the cylinder base and be coupled to the frame 12. The actuator may receive power from the battery, via a battery cable 81 (described below) and the terminal, and the rod may extend from the base, causing the body 14 to be lifted and pivoted relative to the frame 12. Thus, the electrical connections to the actuator may be on the body 14 side of the vehicle, with no direct electrical connections to the actuator on the frame 12 side. This may reduce the complexity of the electrical connections needed on the frame 12 side compared to an embodiment in which the cylinder base is electrically connected to the battery on the frame 12 side and the actuator rod is coupled to the body. In some embodiments, all of the actuators in the vehicle 90 (e.g., lift actuators, tailgate actuators, packer actuators, grabber actuators, etc.) may be electromechanical actuators, and the vehicle 90 may not include a hydraulic tank 79.

Referring now to FIG. 8, a first side (e.g., right-side, etc.) view of a vehicle, shown as refuse vehicle 200 (e.g., a garbage truck, a waste collection truck, a sanitation truck, a recycling truck, etc.), is shown in the first position, according to some embodiments. The vehicle 200 includes a fuel cable (e.g., a conduit, tube, etc.) shown as fuel line 80. The fuel line 80 extends along a top of the body 14 towards the cab 16, extends down a side of the body 14 near the front of the body 14, and includes a first section that couples the generation system 70 to the first body terminal 50 of the body 14, a second section that connects and couples the first body terminal 50 to the first chassis terminal 52 of the chassis 12, and a third section connects and couples the first chassis terminal 52 to the fuel cell 18. In other embodiments, the fuel line 80 may include additional or fewer sections.

The fuel line 80 facilitates the transfer of hydrogen fuel from the generation system 70 to the first body terminal 50, to the first chassis terminal 52, and to the fuel cell 18. In some embodiments, the first body terminal 50 transfers the hydrogen fuel to the various components of the body 14 (e.g., an internal combustion engine, etc.). In some embodiments, the fuel line 80 is configured to couple to the first chassis terminal 52 and transfer hydrogen fuel to various components of the chassis 12, separately from, or in addition to, the fuel cell 18 (e.g., an internal combustion engine, etc.). In some embodiments, the fuel line 80 is configured to connect to similar terminals associated with other components of the vehicle 200.

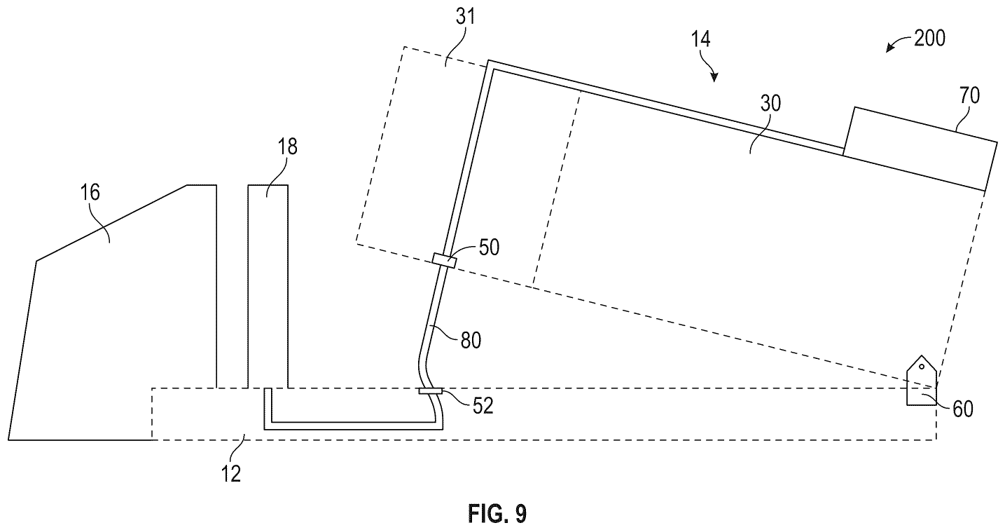

Referring now to FIG. 9, the body 14 (and the first body terminal 50, the second body terminal 54, the battery pack 40, and the generation system 70 stored thereon) is configured to lift relative to the frame 12 by the lift cylinders 17 into the second position. For example, the body 14 may pivot relative to the pivot assembly 60. Accordingly, the fuel line 80 is configured to bend, stretch, and contort as necessary to transition between various positions depending on the position of the body 14 relative to the frame 12. Therefore, the fuel line 80 includes flexible portions of tubing (e.g., the second section of the fuel line 80) and inflexible portions of tubing (e.g., the first section and the third section of the fuel line 80). In some embodiments, the fuel line 80 may be positioned within a cable housing (e.g., a cable track, a cable carrier, a chain housing, a chain conduit, etc.), such that a series of durable housings enclose portions of the fuel line 80 and are linked in order to form angles relative to one another, and to enable pivoting of individual segments of the cable housing relative to one another. Such a configuration may allow the fuel line 80 to flex while being resistant to contacts, pressures, and pinches resulting from the various arrangements of the fuel line 80 disclosed herein.

Referring now to FIGS. 8 and 9, at least a portion of the fuel line 80 (e.g., the flexible portion of the fuel line 80, etc.) is configured to flex at a first angle when the body 14 is in the first position and configured to flex at a second angle when the body is lifted into the second position. In the illustrated embodiment of FIG. 8, when the body 14 is in the first position, the fuel line 80 defines a 180-degree loop or turn (e.g., a half-loop, including two sections of fuel line 80, with one disposed over the other, and extending in a serpentine arrangement), with a first end of the fuel line 80 (e.g., a portion of the fuel line 80 coupled to the first chassis terminal 52) and the second end of the fuel line 80 (e.g., a portion of the fuel line 80 coupled to the fuel cell 18) extending substantially parallel to one another. The 180-degree loop or turn extends from the first body terminal 52, towards the cab 16, and then extends towards the pivot assembly 60.

In some embodiments, the 180-degree loop or turn extends towards the rear of the body 14 and then extends towards the cab 16. After the fuel line 80 completes the 180-degree loop, the fuel line 80 defines a second 180-degree loop or turn. That is, in the first position, the fuel line 80, from the first chassis terminal 52 to the fuel cell 18, extends generally in the direction of the cab 16 for a distance, loops back in the direction of the pivot assembly 60, and extends a distance in the direction of the pivot assembly 60 to define the first 180-degree loop before looping back towards the fuel cell 18 and connecting to the fuel cell 18 to define a second 180-degree loop. Thus, in some embodiments, and as shown in FIG. 8, when the body 14 is in the first position such that the body 14 rests on, or is in full contact with, the frame 12 (e.g., in a fully horizontal orientation), the fuel line 80 is substantially housed within the frame 12. That is, the fuel line 80 may not extend above the upper surface of the frame 12 (e.g., an upper surface of the frame rails 72, 74) or below the lower surface of the frame 12 (e.g., a lower surface of the frame rails 72, 74), and may be positioned between the frame rails 72, 74. In some embodiments, the second 180-degree loop is omitted, such as when the 180-degree loop extends towards the rear of the body 14 first and then extends towards the cab 16. In some embodiments, the 180-degree loop or turn is contained within a cable housing or is at least partially disposed within the cable housing.

As shown in FIG. 9, when the body 14 is lifted and pivoted relative to the frame 12 in the second position, the fuel line 80 flexes into a new arrangement. In the illustrated embodiment, the first end of the fuel line 80 defines an obtuse angle with respect to a third end of the fuel line 80 (e.g., an obtuse angle is defined between a portion of the fuel line 80 coupled to the first chassis terminal 52 and a portion of the fuel line 80 coupled to the first body terminal 50). In some embodiments, the fuel line 80 continues to generally form a back-tracking loop, with a lower portion of the fuel line 80 extending from the first chassis terminal 52 in the direction of the cab 16 and curving rearward toward the pivot assembly 60. Due to the semi-rigid length of the fuel line 80, lifting the body 14 may result in the amount of the fuel line 80 running in the direction of the cab 16 being shorten before looping back toward the pivot assembly 60 as the fuel line 80 progresses from the first chassis terminal 52 to the fuel cell 18.

In some embodiments, and as shown in FIGS. 8 and 9, the fuel line 80 is entirely positioned forward of the pivot assembly 60. In some embodiments, the fuel line 80 may be secured by one or more fasteners (e.g., clips, rings, brackets, etc.) at points on the frame 12 and/or the bottom of the body 14 (or the base 65 of the body 14). For example, the fuel line 80 may be secured at approximately equal intervals (e.g., every 20 inches, 30 inches, etc.). In such cases, securing the fuel line 80 may be facilitated through positioning the fuel line 80 within the cable housing and securing the particular housings of the cable housing as described above.

Referring now to FIGS. 8 and 9, in some embodiments, lengths of the fuel line 80 positioned at stationary areas of the vehicle 200 (e.g., extending across the chassis 12, extending across the body 14) are inflexible solid tubing (e.g., the fuel line 80 along the body 14 is inflexible tubing, etc.). In some embodiments the inflexible solid tubing is metallic tubing mounted to the body 14 or the chassis 12. For example, the fuel line 80 extending along the top of the body 14 and down the side of the body 14 may be inflexible solid tubing coupled directly to the body 14 and the fuel line 80 extending along the bottom of the chassis 12 to the fuel cell 18 may be inflexible solid tubing. Lengths of the fuel line 80 positioned at pivot points or between portions of the vehicle 200 that move relative to one another during operation (e.g., moving parts of the vehicle 200, etc.) are flexible tubing (e.g., soft transfer lines, etc.) and/or contained within a cable housing to constrain movement about an axis, prevent the fuel line 80 from kinking, and ensure the fuel line 80 does not move uncontrolled (e.g., flop, etc.) when the pivot points of the vehicle 200 undergo movement. For example, the fuel line 80 between the first body terminal 50 and the first chassis terminal 52 and the fuel line 80 defining the 180-degree loop coupled to the first chassis terminal 52 may be flexible tubing to enable pivoting movement of the pivot assembly 60 (e.g., the fuel line 80 between the chassis 12 and the body 14 is flexible, etc.).

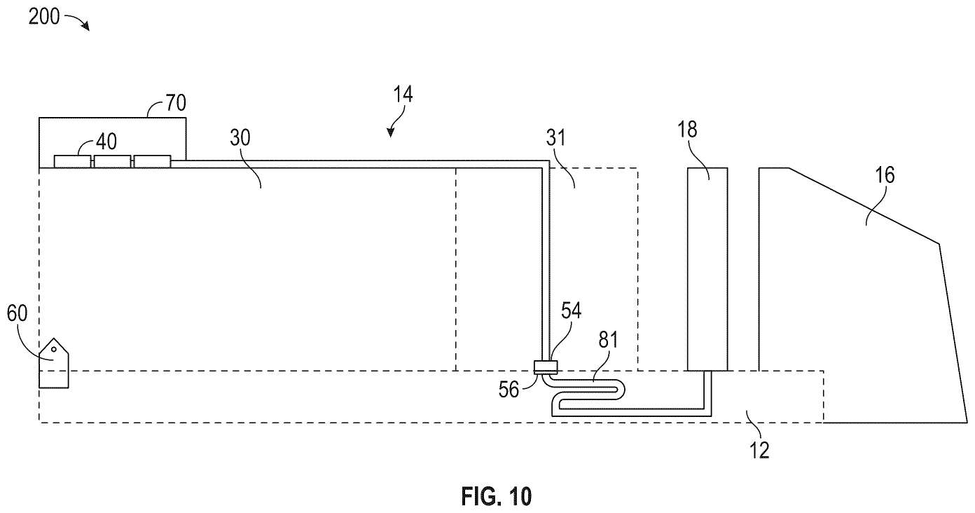

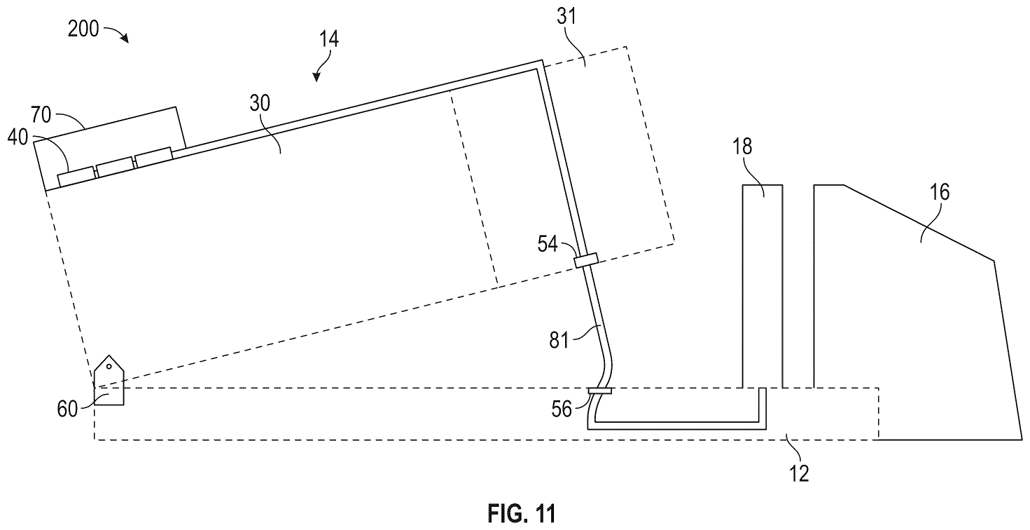

Referring now to FIGS. 10 and 11, second side (e.g., left side, etc.) views of the vehicle 200 of FIGS. 8 and 9, according to some embodiments. The second side views are opposite the first side views. The vehicle 200 includes a cable (e.g., a wire, high voltage cable, which may also include a conduit such as a tube housing electrical wiring, etc.), shown as battery cable 81. The battery cable 81 is configured similarly to the fuel line 80 of FIGS. 9 and 10 in the first position and the second position. However, the battery cable 81 electrically connects the battery pack 40 to the second body terminal 54 of the body 14, electrically connects the second body terminal 54 to the second chassis terminal 56 of the chassis 12, and electrically connects the second chassis terminal 56 to the fuel cell 18.

In some embodiments, the battery pack 40 includes a disconnect box to electrically couple the battery pack 40 to one end of the battery cable 81. As such, the battery cable 81 may facilitate the transfer of electrical energy from the battery pack 40 to the first body terminal 50, which in turn transfers the electrical energy to the various electrical components of the body 14. In some embodiments, the battery cable 81 is configured to supply power to other components of the vehicle 200, such as the electric motor 57, the cab 16, and/or other electrical equipment. In some embodiments, the battery cable 81 may transfer electrical energy to the various electrical components of the chassis 12. In the illustrated embodiment, the battery pack 40 is electrically coupled to the second body terminal 54 of the body 14. In some embodiments, the battery cable 81 is configured to couple to similar terminals associated with other components of the vehicle 200. In some embodiments, the terminals may be configured to distribute power to components beyond those which are associated with the body 14.

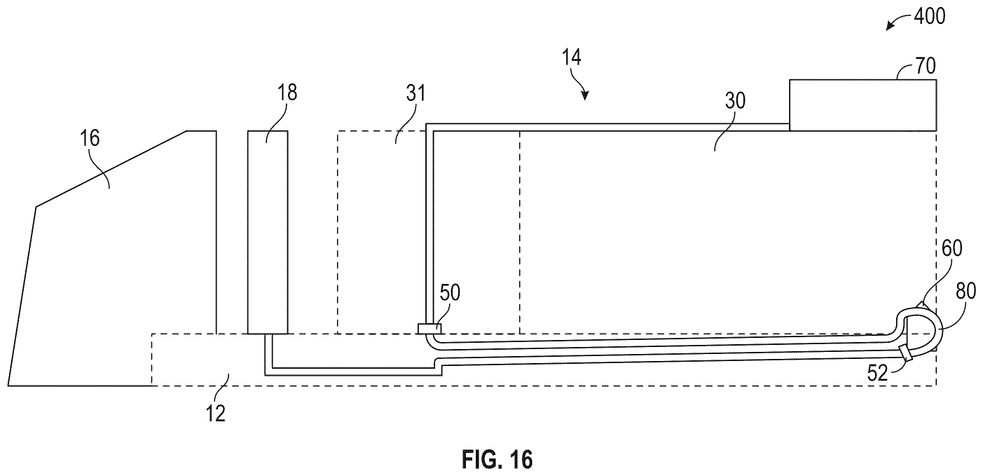

Arranging the battery cable 81 as shown in FIGS. 10 and 11 can reduce an amount of electrical loss associated with the length of the battery cable 81 used to couple the battery pack 40 to the second body terminal 54 and/or the second chassis terminal 56 (or other components of the vehicle 200). For example, the length of the battery cable 81 as shown may be less than the length of the battery cable 81 necessary in other system arrangements, such as the arrangement of the battery cable 81 as depicted with reference to FIGS. 16 and 17 or FIGS. 30 and 31, described in greater detail below.

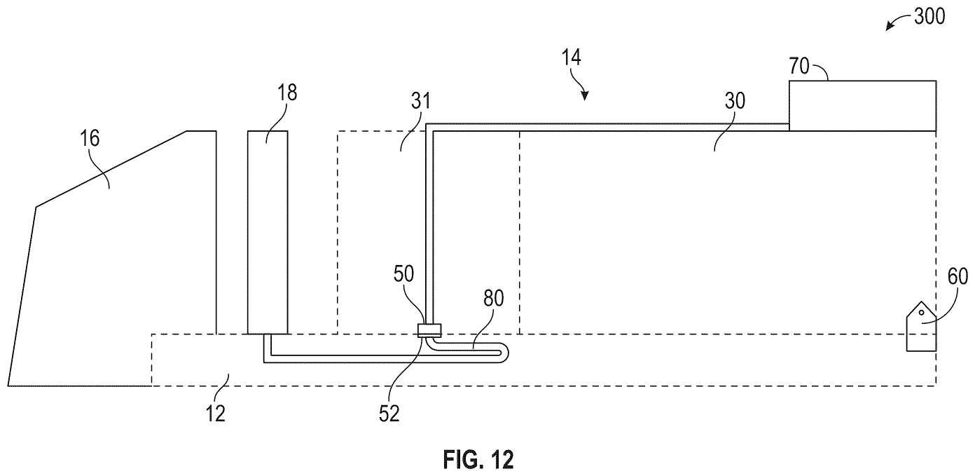

Referring now to FIG. 12, a first side (e.g., a right-side, etc.) view of a vehicle, shown as refuse vehicle 300 (e.g., a garbage truck, a waste collection truck, a sanitation truck, a recycling truck, etc.) is shown the first position, according to some embodiments. The fuel line 80 is configured similarly to the fuel line 80 of FIG. 8. However, the fuel line 80 extends from the first chassis terminal 52 in the direction of the pivot assembly 60, loops back toward the cab 16, extends toward the cab 16, and couples to the fuel cell 18. That is, the second 180-degree loop is omitted, and the first 180-degree loop direction is opposite that of the first 180-degree loop in the embodiment of FIG. 8.

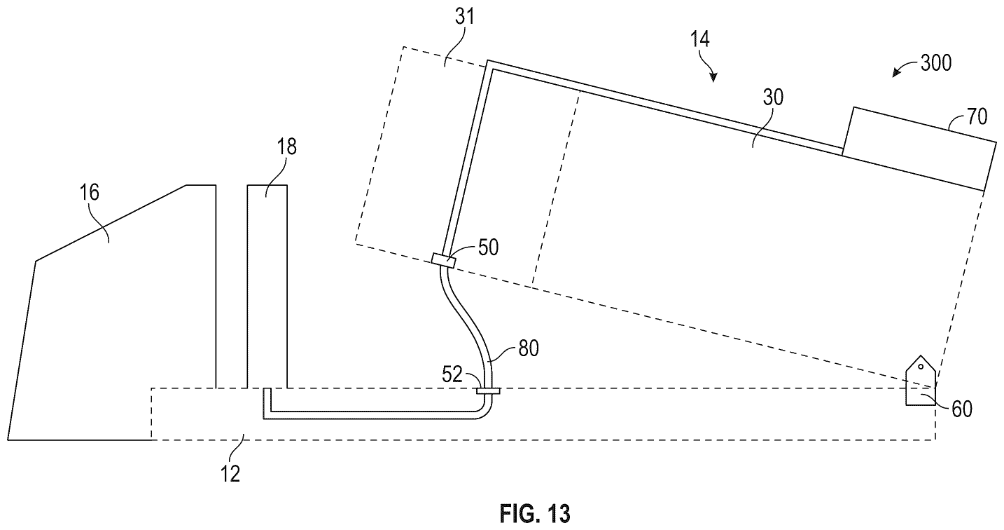

Referring now to FIG. 13, the body 14 of FIG. 12 is shown in the second position. The fuel line 80 flexes in the opposite direction as shown in FIG. 9 to couple the first chassis terminal 52 to the fuel cell 18. Specifically, the portion of the fuel line 80 extending from the first chassis terminal 52 extends towards the cab 16 instead of curving back towards the pivot assembly 60 before curving upward and forward towards the cab 16 as in FIG. 9.

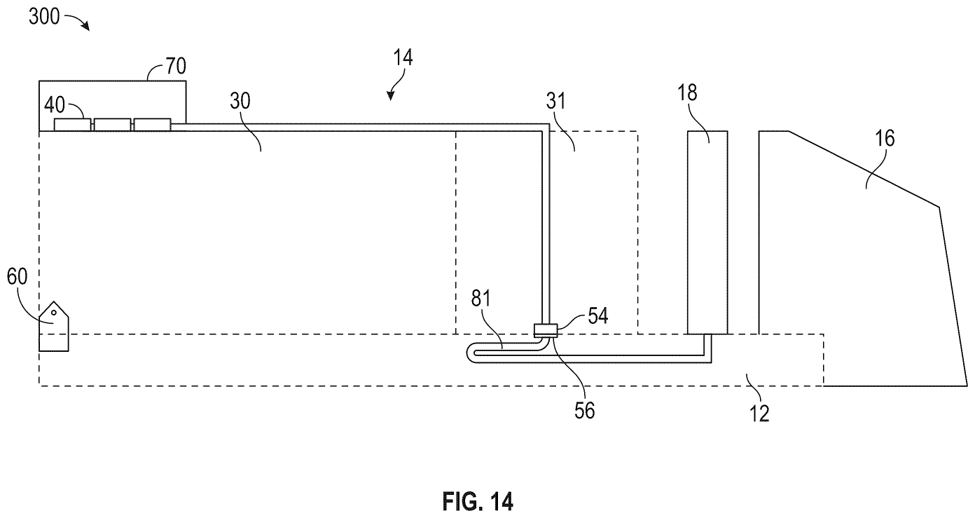

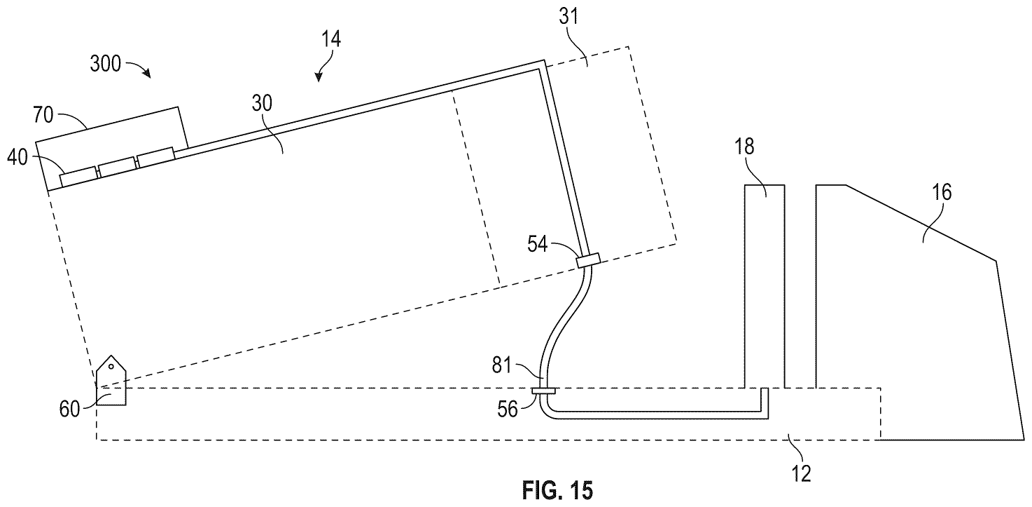

Referring now to FIGS. 14 and 15, second side views of the vehicle 300 of FIGS. 12 and 13 in the first position and the second position are shown, respectively. The battery cable 81 is configured similarly to the fuel line 80 of FIGS. 12 and 13. However, the battery cable 81 extends from battery pack 40 to the second body terminal 54, from the second body terminal 54 to the second chassis terminal 56 and from the second chassis terminal 56 to the fuel cell 18.

Referring now to FIG. 16, a first side (e.g., a right-side, etc.) view of a vehicle, shown as refuse vehicle 400 (e.g., a garbage truck, a waste collection truck, a sanitation truck, a recycling truck, etc.), is shown in the first position, according to an embodiment. The fuel line 80 is configured similarly to the fuel line 80 of FIG. 12. However, the first chassis terminal 52 is located near the pivot assembly 60 (e.g., the first chassis terminal 52 is located closer to the pivot assembly 60 than the first body terminal 50, etc.). The fuel line 80 extends from the first body terminal 50 towards the pivot assembly 60, around a pivot (e.g., the pivot or crossbar 66 of the pivot assembly 60 depicted in FIG. 33) of the pivot assembly 60, couples to the first chassis terminal 52, and extends back towards the cab 16 until the fuel line 80 couples to the fuel cell 18. In some embodiments, and as shown, the fuel line 80 extends around the pivot 66 from below, around the back of the pivot 66, and over the pivot 66. Thus, in some embodiments, the fuel line 80 may include a 180-degree loop that extends above the frame rails 72, 74, while the first and second ends do not extend above or below the frame rails 72, 74 and are substantially parallel to each other. The routing of the fuel line 80 around the pivot 66 as depicted is described in greater detail below with reference to FIG. 33. In some embodiments the loop around the pivot may be contained within a cable housing.

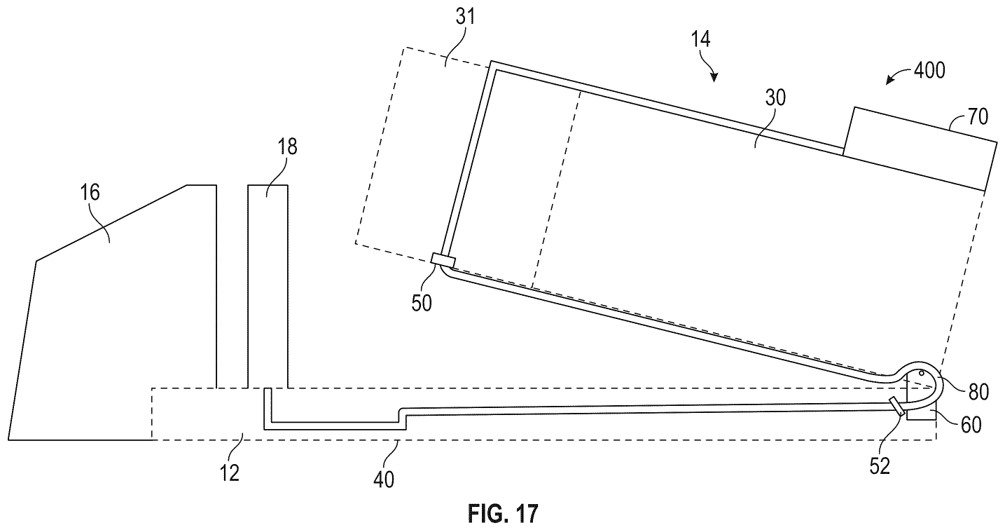

Referring now to FIG. 17, the fuel line 80 is shown as arranged with reference to FIG. 16, with the body 14 lifted relative to the frame 12 in the second position, according to an embodiment. The fuel line 80 extends around the pivot 66 (e.g., wraps around the pivot 66, etc.) as described above with reference to FIG. 16 and is flexed (relative to the position of the battery cable 81 as depicted above with reference to FIG. 16) to connect to the first chassis terminal 52. Because the fuel line 80 extends around the pivot 66, the fuel line 80 does not swing (e.g., hang down, droop, sag, etc.) from the underside of the body 14 when the body 14 is lifted in the second position. Instead, the fuel line 80 is fixed against the underside of the body 14. In some embodiments, and as shown, the fuel line 80 includes inflexible sections of tubing along the top and side of the body 14, along a bottom of the body 14, and along the chassis 12. The fuel line 80 includes flexible tubing at and/or around the pivot assembly 60. In some embodiments, the fuel line 80 is flexible between the first body terminal 50 and the first chassis terminal 52 (e.g., the fuel line 80 between the chassis 12 and the body 14 is flexible, etc.). Such an arrangement, as described with reference to FIGS. 16 and 17, can eliminate or reduce the need for a cable housing to support the flexible section of the fuel line 80.

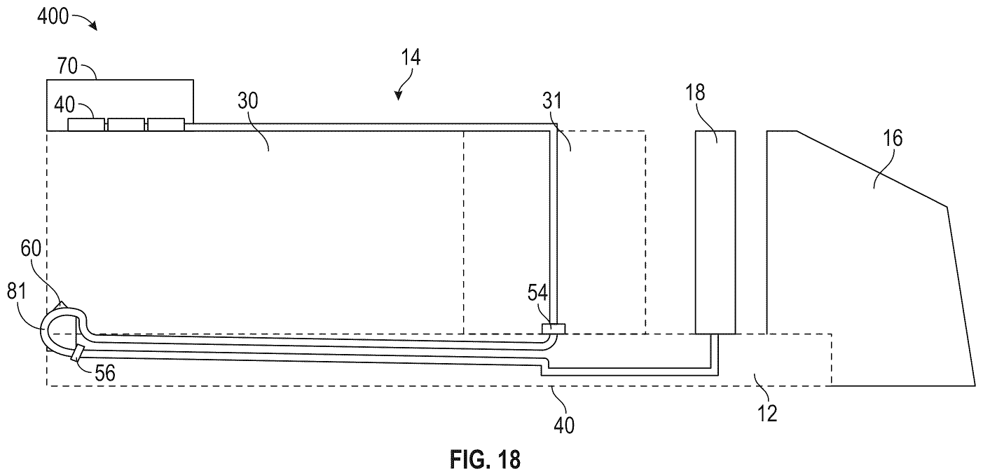

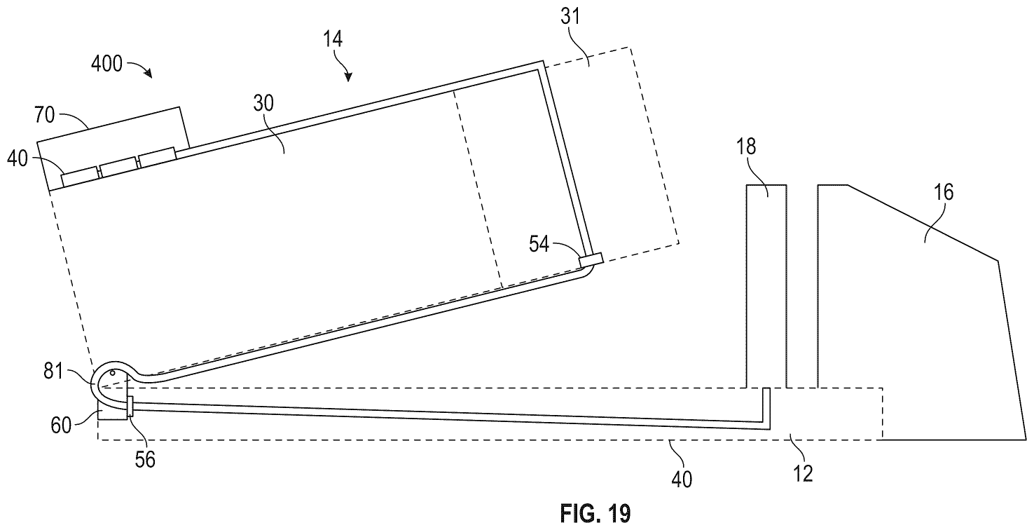

Referring now to FIGS. 18 and 19, second side (e.g., left side, etc.) views of the vehicle 400 of FIGS. 16 and 17 in the first position and the second position, respectively, are shown, according to an embodiment. In the illustrated embodiment, the battery cable 81 is configured similarly to the fuel line 80 of FIGS. 18 and 19 and the second chassis terminal 56 is configured similarly to the first chassis terminal 52 of FIGS. 18 and 19. However, the battery cable 81 of FIGS. 18 and 19 electrically couples the battery pack 40 to the second body terminal 54, the second body terminal 54 to the second chassis terminal 56, and the second chassis terminal 56 to the fuel cell 18.

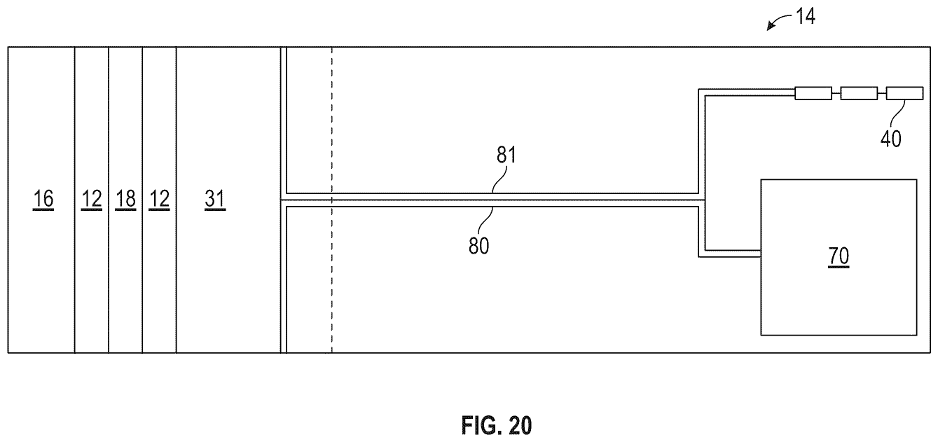

Referring now to FIG. 20 a top view of the vehicles (200, 300, and 400) of FIGS. 8, 12, and 16 is shown, according to some embodiments. A first section of the fuel line 80 extends from the generation system 70 towards the cab 16 and a first section of the battery cable 81 extends from the battery pack 40 towards the cab 16. A second section of the fuel line 80 and the battery cable 81 extend from the first section towards a center of the top of the body 14 until the fuel line 80 and the battery cable 81 contact. The second section of the fuel line 80 and the battery cable 81 extend side by side along the top of the body 14 towards the cab 16 (e.g., towards the front of the body 14, etc.) until near or at the front of the body 14 closest to the cab 16. From or at the front of the body 14 (e.g., at an upper end of a front of the body 14, at a lower end of a front of the body 14), a third section of the fuel line 80 and the battery cable 81 separate and extend in opposite directions towards opposite sides of the body 14. In some embodiments the third section of the fuel line 80 and the battery cable 81 extend down opposite sides of the body 14.

The fuel line 80 extends along the top of the body 14 and down a first side of the body 14. The battery cable 81 extends along the top of the body 14 and down a second side of the body 14 opposite the first side of the body 14. In some embodiments, where the fuel line 80 and the battery cable 81 extend together along the body 14, the fuel line 80 and the battery cable 81 are enclosed together (e.g., received, etc.) within a rigid casing designed for protection (e.g., from puncture, harsh winds, etc.).

Among other benefits, separating a terminating or connecting end of the battery cable 81 and the fuel line 80 on alternate sides of the body 14 can prevent explosions, since separating the fuel line 80 and the battery cable 81 can decrease the likelihood that leaked hydrogen gas will interact with electrical hazards (e.g., sparking from the battery cable 81). Leaked hydrogen may be released from gas fittings over a period of time after repeated body 14 operation (e.g., after repeated raising and lowering of the body 14, etc.). Avoiding the leaked hydrogen interacting with sparking is important for reducing fire hazards. In some embodiments, the fuel line 80 and the battery cable 81 in the top view are received within inflexible conduit (e.g., rigid tubing). In some embodiments the fuel line 80 and the battery cable 81 are coupled directly to the body 14. In some embodiments the portions of the fuel line 80 and the battery cable 81 extending along the first side of the body and the second side of the body include inflexible tubing.

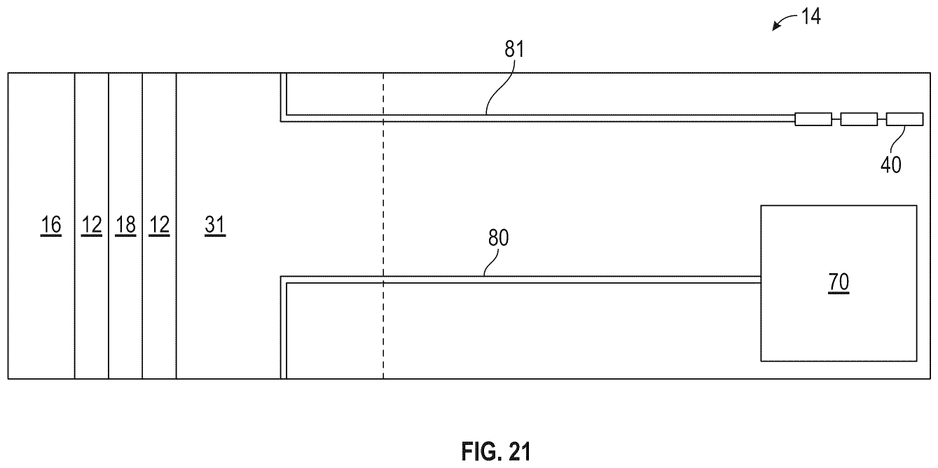

Referring now to FIG. 21 a top view of the vehicles (200, 300, and 400) of FIGS. 8, 12, and 16, according to some embodiments. The embodiment of FIG. 21 is similar to the embodiment of FIG. 20, however the battery cable 81 and the fuel line 80 remain separated along the entirety of the top of the body 14. Separating the battery cable 81 and the fuel line 80 along the entirety of the top of the body 14 may further reduce the likelihood leaked hydrogen gas will interact with electrical hazards.

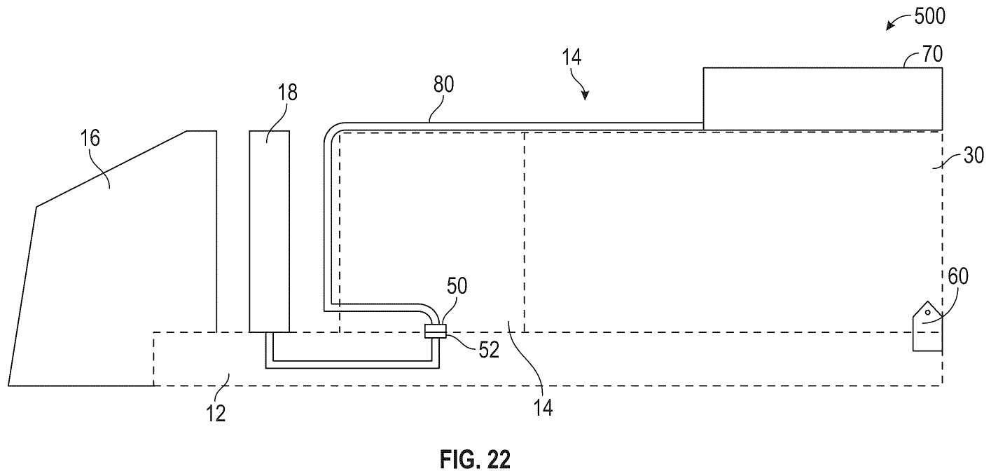

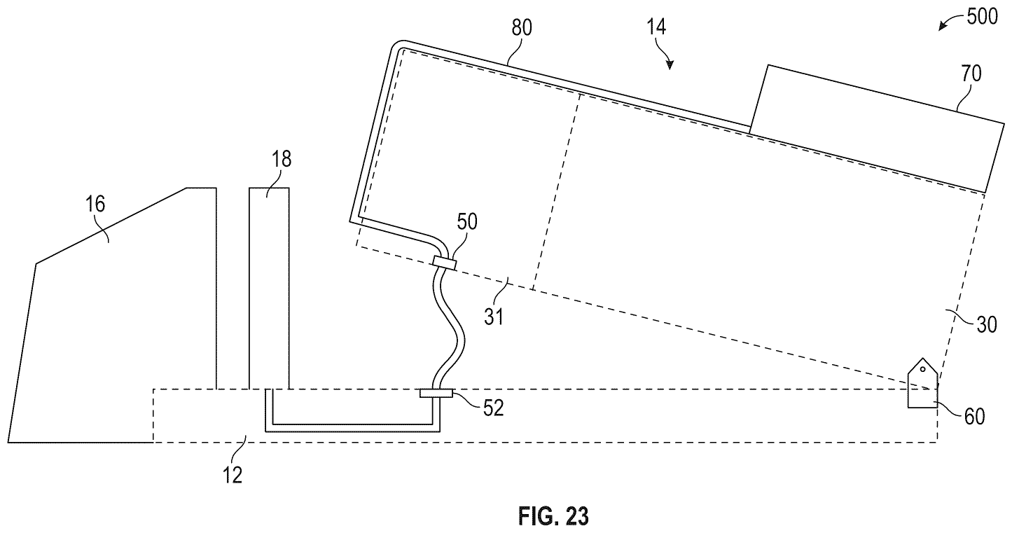

Referring now to FIGS. 22 and 23, first side (e.g., right side, etc.) views of a vehicle, shown as refuse vehicle 500 (e.g., a garbage truck, a waste collection truck, a sanitation truck, a recycling truck, etc.), according to some embodiments. The vehicle 500 of FIGS. 22 and 23 is similar to the embodiment of FIGS. 12 and 13. However, in the embodiment of FIGS. 22 and 23, the fuel line 80 includes a first section that extends around a top-forward corner of the body 14, a second section that extends downward along the front of the body 14 towards the chassis 12, and a third section that extends around or proximate to a bottom-forward corner of the body 14 towards the pivot 66, a fourth section that extends into the first body terminal 50 (e.g., toward the frame 12), and a fourth section that extends along (and/or within) the frame 12 away from the pivot 66 to couple to the fuel cell 18. The loop from the embodiment of FIGS. 12 and 13 is omitted from FIG. 22 but may also be present (e.g., either between frame rails of the chassis 12, laterally alongside the frame rails, or in another location adjacent to where the body 14 rests on the chassis 12. In some embodiments, the first body terminal 50 may be positioned closer to the front portion of the body 14 closest to the cab 16 to reduce an overall length of the fuel line 80. In some embodiments, the first chassis terminal 52 may be positioned closer to the front portion of the chassis 12 closest to the cab 16 to reduce overall length of the fuel line 80. In some embodiments, the fuel line 80 includes inflexible tubing along the top, front side, and side of the body 14, and along the chassis 12. In the embodiment shown, the fuel line 80 includes flexible tubing between the first body terminal 50 and the first chassis terminal 52 (e.g., the fuel line 80 between the chassis 12 and the body 14 is flexible, etc.), and may be configured similar to the flexible fuel line 80 section described in earlier figures.

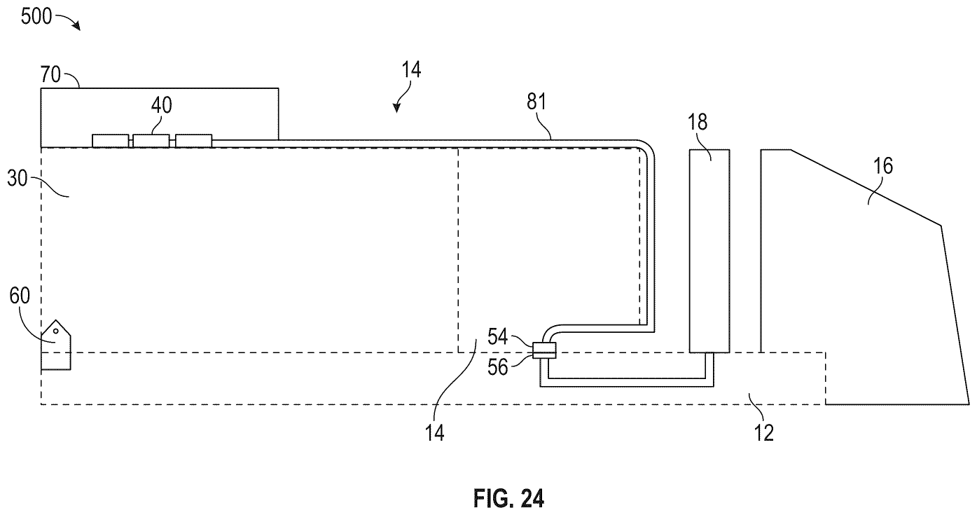

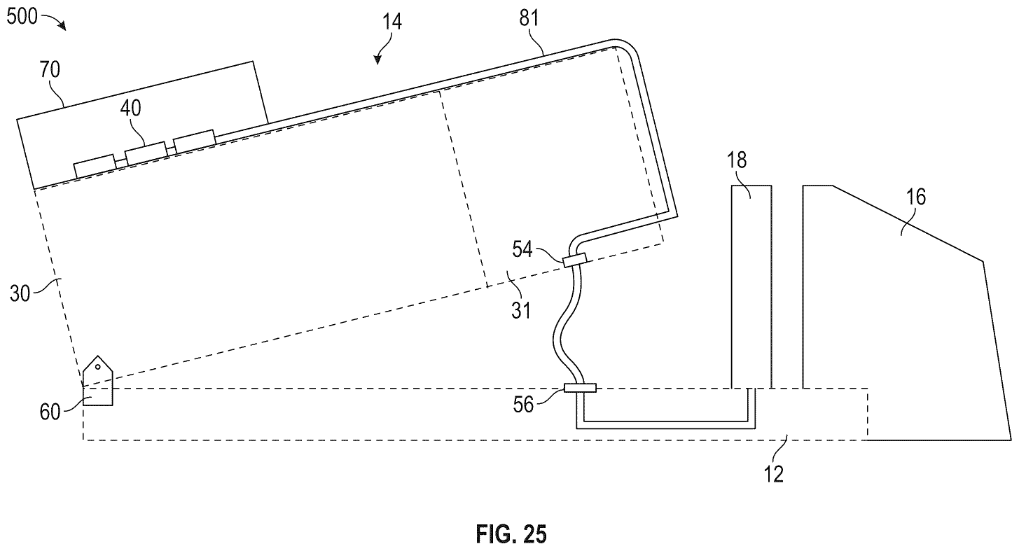

Referring now to FIGS. 24 and 25, second side (e.g., left side, etc.) view of the vehicle 500 of FIGS. 22 and 23 is shown, according to another embodiment. The embodiment of the battery cable 81 in FIGS. 24 and 25 is similar to the embodiment of the fuel line 80 FIGS. 22 and 23. In the embodiment of FIGS. 24 and 25, battery cable 81 electrically couples the battery pack 40 to the second body terminal 54, the second body terminal 54 to the second chassis terminal 56, and the second chassis terminal 56 to the fuel cell 18.

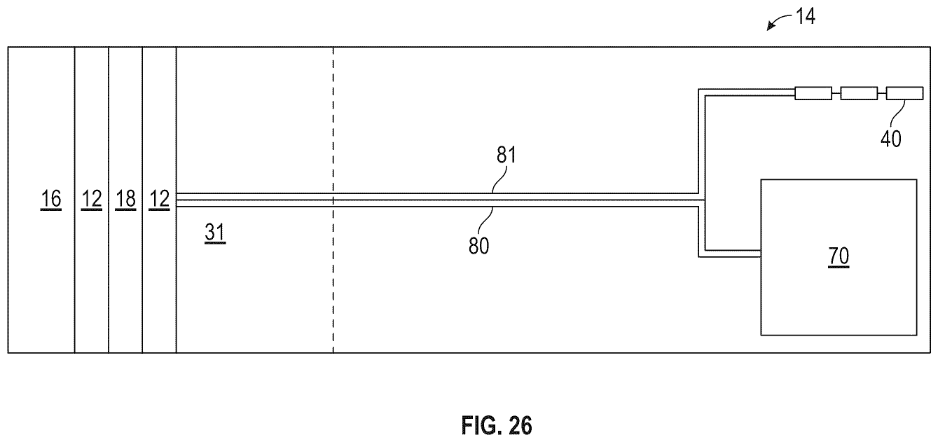

Referring now to FIG. 26, a top view of the vehicle 500 of FIG. 22 is shown, according to another embodiment. The top view of the vehicle 500 of FIG. 26 is similar to the top view of FIG. 20. However, the battery cable 81 and the fuel line 80 both extend down the front side of the body 14 (e.g., the side of the body 14 facing the fuel cell 18, etc.). At or proximate to the front of the body 14, the fuel line 80 and the battery cable 81 separate and extend in opposite directions while extending down the front side of the body 14. In some embodiments, portions of the fuel line 80 and the battery cable 81 that extend along the front of the body 14 are comprised of inflexible tubing.

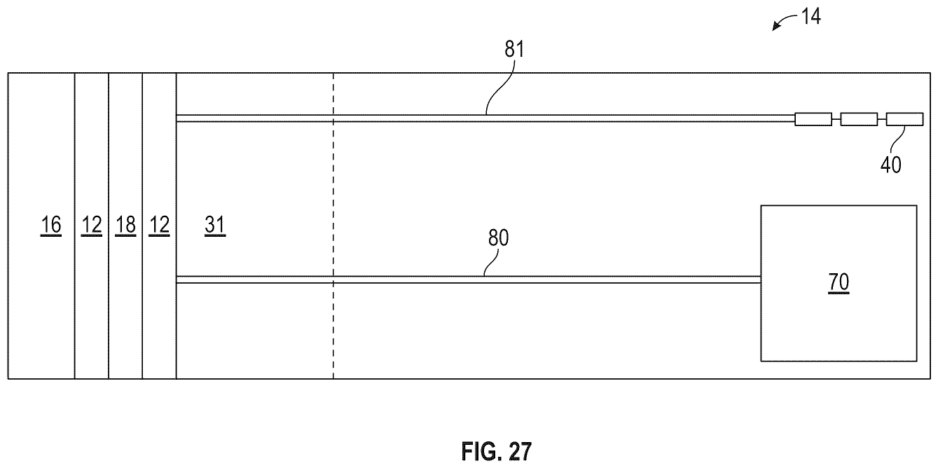

Referring now to FIG. 27, a top view of the vehicle 500 of FIG. 22is shown, according to an embodiment. The top view of the vehicle 500 of FIG. 27 is similar to the top view of FIG. 26. However, the battery cable 81 and the fuel line 80 remain separated along the top of the body 14. The battery cable 81 and the fuel line 80 extend substantially parallel to one another along the top of the body 14.

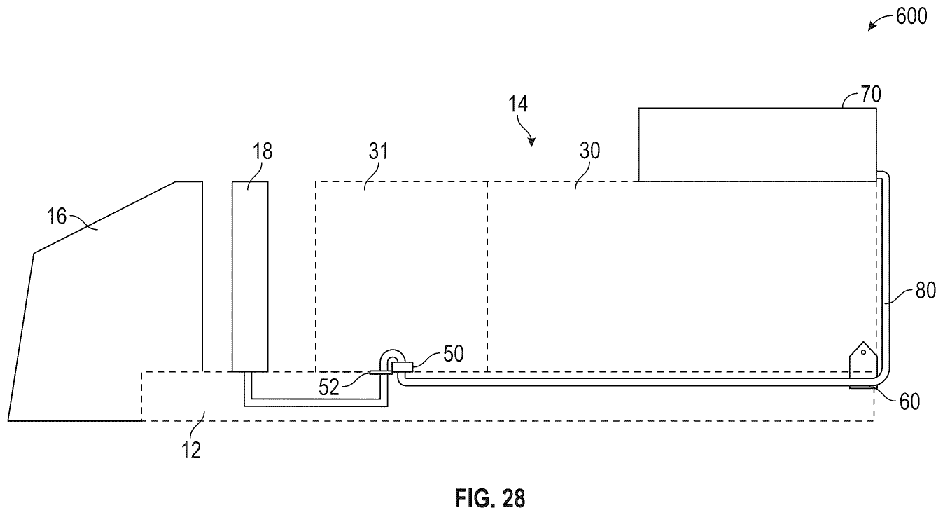

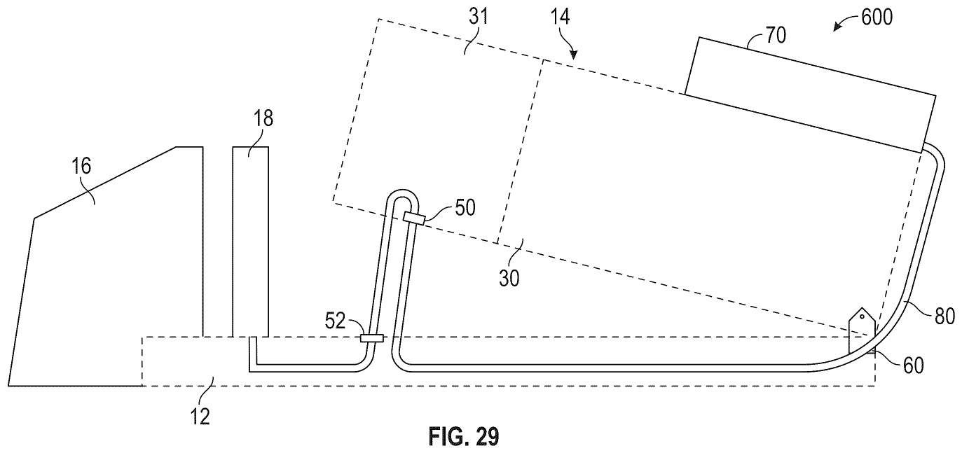

Referring now to FIGS. 28 and 29, first side (e.g., right side, etc.) views of a vehicle, shown as refuse vehicle 600 (e.g., a garbage truck, a waste collection truck, a sanitation truck, a recycling truck, etc.) are shown in the first position and the second position, respectively, according to yet another embodiment. The refuse vehicle 600 of FIGS. 28 and 29 is similar to the embodiment of the refuse vehicle 500 of FIGS. 22 and 23. However, the fuel line 80 extends from the generation system 70 to the first body terminal 50 by extending along top-rear corner of the body 14, down a rear face of the body 14, around the pivot 66 to the frame 12, and along (and within, in some embodiments) the frame 12 in the direction of the cab 16 to couple to the first body terminal 50. In some embodiments, the fuel line 80 may extend along the bottom rear corner of the body 14 without running around the pivot 66. For example, the fuel line 80 may be inflexible and mounted along the back of the body 14 and along a portion of chassis 12. To continue this example, the fuel line 80 may include flexible between the first body terminal 50 and the first chassis terminal 52 (e.g., the fuel line 80 between the chassis 12 and the body 14 is flexible, etc.) and between the first body terminal 50 and the pivot assembly 60. In another example, the fuel line 80 may be comprised of flexible tubing at the back of the body 14 between the generation system 70 and the pivot assembly 60. In another example, the fuel line 80 may be comprised of inflexible tubing and mounted to the bottom of the body 14. In some embodiments, the fuel line 80 around the pivot may be contained within a cable housing.

Referring now to FIG. 29, the fuel line 80 is shown in the arrangement depicted with reference to FIG. 28 with the body 14 in the second position, according to some embodiments. In some embodiments, the fuel line 80 may bend, flex, and extend in various directions to facilitate the lifting of the body 14. Alternatively, the fuel line 80 may remain secured against the rear and underside of the body 14.

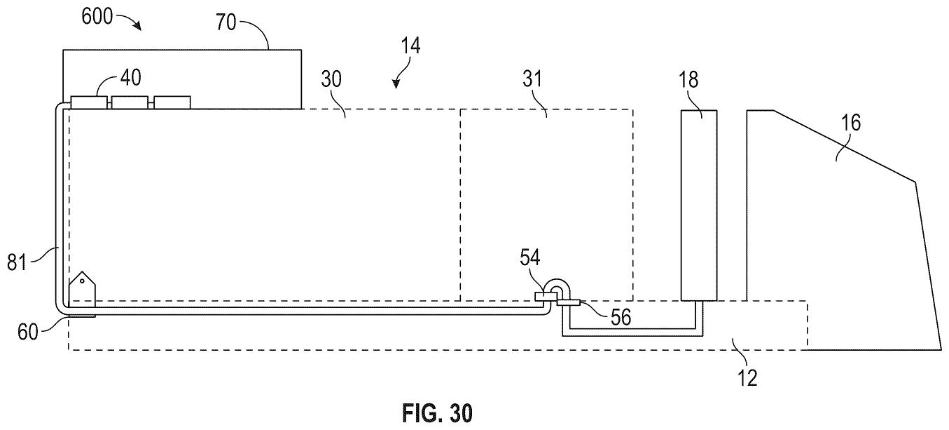

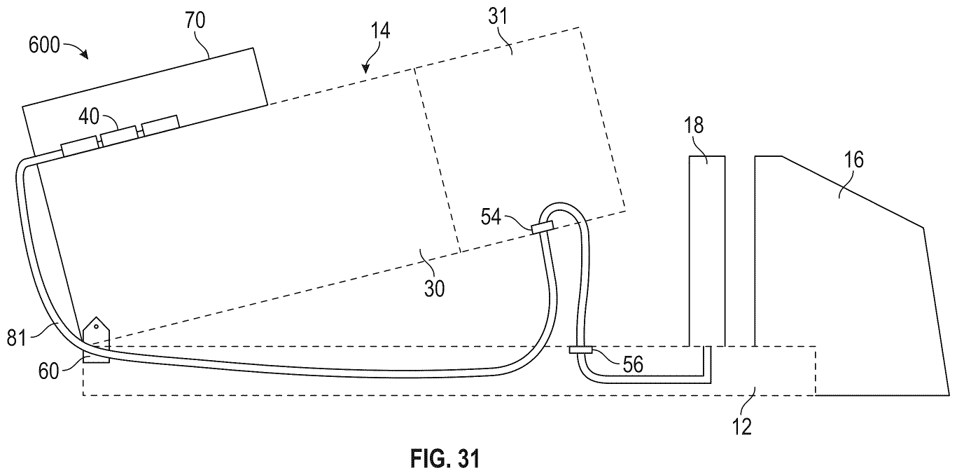

Referring now to FIGS. 30 and 31, second side (e.g., left side, etc.) views of the vehicle 600 of FIGS. 28 and 29 are shown, according to an embodiment. The embodiment of the battery cable 81 of FIGS. 30 and 31 is similar to the embodiment of the fuel line 80 of FIGS. 28 and 29. However, in the embodiment of FIGS. 30 and 31, the battery cable 81 couples the battery pack 40 to the second body terminal 54, the second body terminal 54 to the second chassis terminal 56, and the second chassis terminal 56 to the fuel cell 18.

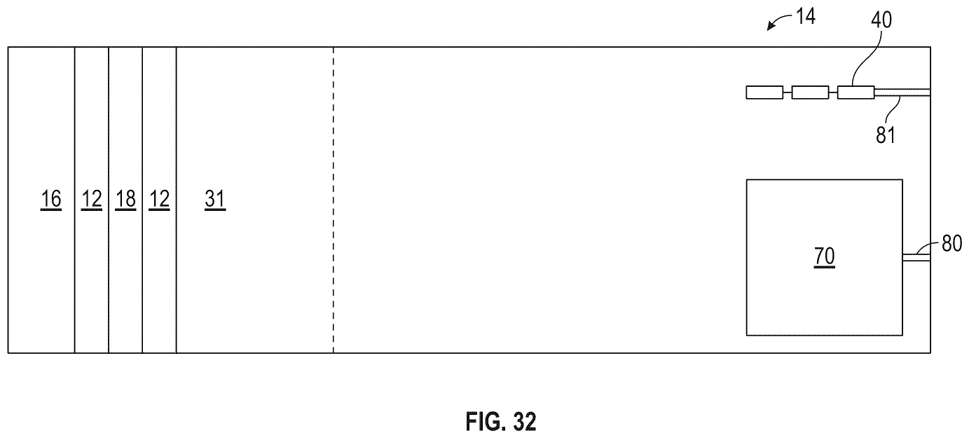

Referring now to FIG. 32, a top view of the vehicle 600 shown in FIG. 28 is shown, according to an embodiment. The battery cable 81 extends from the battery pack 40 and the fuel line 80 extends from the generation system 70 towards the rear of the body 14 and down the side of the body 14. After extending past the top of the body 14 and along the rear of the body 14, the battery cable 81 and the fuel line 80 extend in opposite directions to opposite sides of the body 14. In some embodiments the battery cable 81 and the fuel line 80 include at least one section of inflexible tubing mounted to the top of the body 14. In other embodiments, such as when the battery cable 81 and the fuel line 80 are not fixed to the rear of the body 14, the battery cable 81 and the fuel line 80 may include flexible tubing.

Referring now to FIG. 33, the fuel line 80 of the vehicle (100, 400, 600) is schematically shown navigating (e.g., running around) the pivot 66 of the pivot assembly 60, according to an embodiment. As shown, the frame 12 includes a left rail 72 and a right rail 74 (from the perspective of the rear face of the vehicle). The base 65 may form a similar pair of separate rails 76, 78, as shown, that may form part of the pivot assembly 60. In other embodiments, the base 65 is a solid member filling the entire cavity depicted between the separate rails 76, 78. The crossbar or pivot 66 may run laterally between two members 82, 84 of the pivot assembly 60 to facilitate the rotatable coupling of the body 14 to the frame 12. The two members 82, 84 of the pivot assembly 60 may be coupled to the rails 72, 74 of the frame 12. The crossbar 66 may be coupled to the two members 82, 84 (e.g., brackets, plates, etc.) of the pivot assembly 60 and to the two rails 76, 78 of the base 65. The crossbar 66 may be rotatably coupled to the rails 76, 78, to the members 82, 84, or to the rails 76, 78 and the members 82, 84 to enable the body 14 to pivot relative to the frame 12. Thus, in some embodiments, when the body 14 is lifted relative to the frame 12, a portion of the weight of the body 14 (that is not supported by the lift cylinders 17) is supported via the base 65 being supported by the crossbar 66, which in turn is supported by the two members 82, 84 of the pivot assembly 60, which in turn are supported by the frame 12 (e.g., the left rail 72 and the right rail 74 of the frame 12), which are in turn generally supported by the wheels 22. In some embodiments, the rails 72, 74 or another member of the frame 12 may be directly coupled to the crossbar 66, and the members 82, 84 may not be required. For example, the rails 76, 78 may extend farther downward, or the rails 72, 74 may extend further upward in the area of the pivot assembly 60 such that the crossbar 66 may be coupled to both the rails 76, 78 and the rails 72, 74.

As shown, the fuel line 80 may run between the left member 82 of the pivot assembly 60 and the left rail 76 of the base 65. In other embodiments, the fuel line 80 runs in between the separate rails 76, 78 of the base 65. In other embodiments still, the fuel line 80 runs outside of the frame 12 (e.g., around the members 82, 84 of the pivot assembly 60). As shown, the fuel line 80 may run from the generation system 70, reach the pivot assembly 60 below the crossbar 66 (represented by the cross-section portion of the battery cable 81 represented by a dot symbol, indicating the fuel line 80 is extending out of the page and away from the cab 16), around and above the crossbar 66, (represented by the “X” symbol, indicating that the fuel line 80 is extending into the page and towards the cab 16) and back along the underside of the body 14.

Referring now to FIG. 34, the battery cable 81 of the vehicle (100, 400, 600) is schematically shown navigating (e.g., running around) the pivot 66 of the pivot assembly 60, according to an embodiment. As shown, the battery cable 81 may run between the left member 82 of the pivot assembly 60 and the left rail 76 of the base 65. In other embodiments, the battery cable 81 runs in between the separate rails 76, 78 of the base 65. In other embodiments still, the battery cable 81 runs outside of the frame 12 (e.g., around the members 82, 84 of the pivot assembly 60). As shown, the battery cable 81 may run from the battery pack 40, reach the pivot assembly 60 below the crossbar 66 (represented by the cross-section portion of the battery cable 81 represented by a dot symbol, indicating the battery cable 81 is extending out of the page and away from the cab 16), around and above the crossbar 66, (represented by the “X” symbol, indicating that the battery cable 81 is extending into the page and towards the cab 16) and back along the underside of the body 14.

### Hydrogen Generation System for Vehicle

Referring to FIGS. 35-37, a vehicle, shown as refuse vehicle 1000 (e.g., a garbage truck, a waste collection truck, a sanitation truck, a recycling truck, etc.) includes an energy system, shown as hydrogen system 1001. The hydrogen system 1001 includes the generation system 70, and a hydrogen power system, shown as power system 1110, coupled to the generation system 70. The hydrogen system 1001 is configured to generate hydrogen (e.g., H₂, hydrogen gas, hydrogen liquid, etc.) and power one or more components of the refuse vehicle 1000 using the generated hydrogen (e.g., as fuel for a hydrogen internal combustion engine, as fuel for a hydrogen fuel cell, etc.). More specifically, the generation system 70 is configured to receive a hydrogen donor fluid such as water (e.g., H₂O, steam, water vapor, liquid water, etc.), a hydrocarbon (e.g., methane (CH₄), etc.), or another suitable hydrogen donor fluid (e.g., alcohols, hydrides, etc.). The generation system 70 is supplied with energy (e.g., electric energy) to perform a hydrogen generation process (e.g., water splitting such as electrolysis, hydrocarbon reforming such as steam reforming, hydrocarbon/methane pyrolysis, etc.) using the fluid to generate hydrogen. The hydrogen is then supplied to the power system 1110 and used as fuel such that the power system 1110 generates energy to power one or more components of the refuse vehicle 1000. The power system 1110 of the hydrogen system 1001 may operate alone or in combination with one or more power systems of the refuse vehicle 1000 (e.g., the prime mover 21, a battery pack 1040, the electric motor 57, the hydraulic pump 58, etc.) to power one or more components of the refuse vehicle 1000. In this manner, the hydrogen system 1001 is configured to provide energy to perform at least one of a driving operation or a body operation of the refuse vehicle 1000.

Referring to FIG. 35, the hydrogen system 1001 and the components included therein (e.g., the generation system 70 and the power system 1110) may be variously positioned about the refuse vehicle 1000. In some embodiments, the hydrogen system 1001 is supported by the frame 12. In other embodiments, the hydrogen system 1001 may be positioned along and supported by the body 14, the cab 16, and/or the tailgate 34 of the refuse vehicle 1000. In yet other embodiments, the hydrogen system 1001 is otherwise positioned along and support by one or more components of the refuse vehicle 1000. In some embodiments, a first component of the hydrogen system 1001 (e.g., the generation system 70) is positioned at a first location and a second component of the hydrogen system 1001 (e.g., the power system 1110) is positioned at a second location different than the first location.

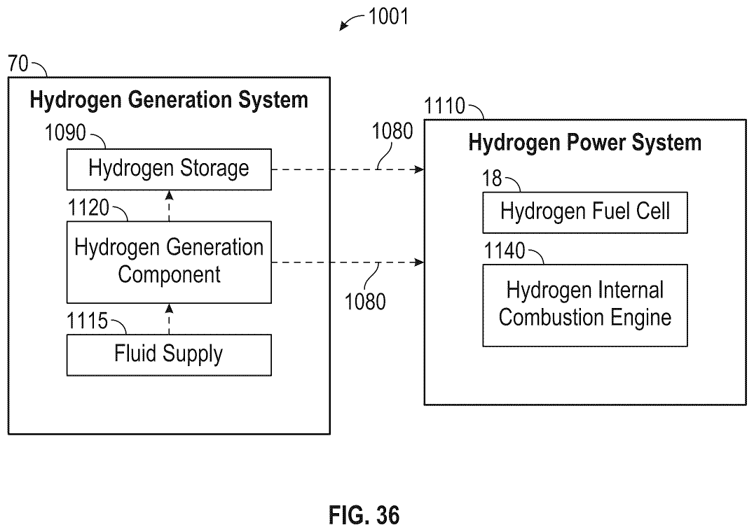

Referring to FIG. 36, the generation system 70 includes a fluid supply source (e.g., reservoir, tank, cylinder, container, vat, drum, canister, vessel, etc.), shown as fluid supply 1115; a hydrogen generation component (e.g., a reactor, a reformer, an electrolyzer, etc.), shown as hydrogen generation component 1120; a fluid supply conduit (e.g., hose, pipe, tube, etc.), shown as the fuel line 1080; and a hydrogen reservoir (e.g., tank, cylinder, container, vat, drum, canister, vessel, etc.), shown as hydrogen storage 1090.

The fluid supply 1115 is configured to contain a volume of the hydrogen donor compound. The hydrogen donor compound may be a fluid (e.g., liquid or gas) including hydrogen and capable of donating one or more hydrogen atoms (hereinafter referred to as the fluid). In some embodiments, the fluid is water (e.g., H₂O, steam, water vapor, liquid water, etc.). In other embodiments, the fluid is a hydrocarbon (e.g., methane (CH₄), natural gas, propane, butane, ethane, pentane, etc.) and/or another suitable hydrogen donor fluid (e.g., alcohols, hydrides, etc.). The type of the fluid stored within the fluid supply 1115 depends on the hydrogen generation process to be performed by the hydrogen generation component 1120 to generate the hydrogen. By way of example, if the hydrogen generation component 1120 is configured to perform an electrolysis process (as described in greater detail herein), the fluid may be water. By way of another example, is the hydrogen generation component 1120 is configured to perform a methane pyrolysis process (as described in greater detail herein), the fluid may be methane.

The fluid supply 1115 may be refillable with the fluid and capable of repeated use. By way of example, at the start of, during, or after a route driven by the refuse vehicle 1000, on operator may refill the fluid supply 1115 with the fluid. In some embodiments, the fluid supply 1115 is designed for one-time use such that the fluid supply 1115 is not refilled or reused. In some embodiments, the hydrogen system 1001 includes two or more fluid supplies 1115.

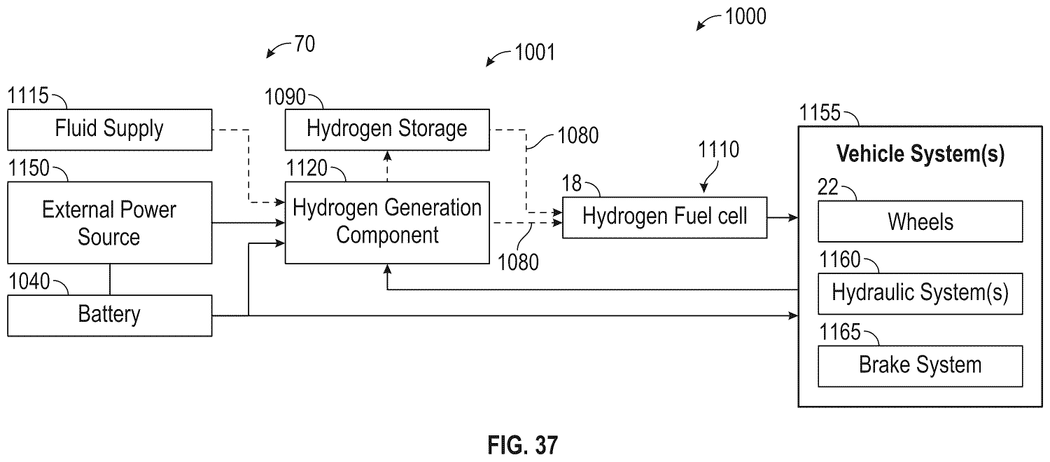

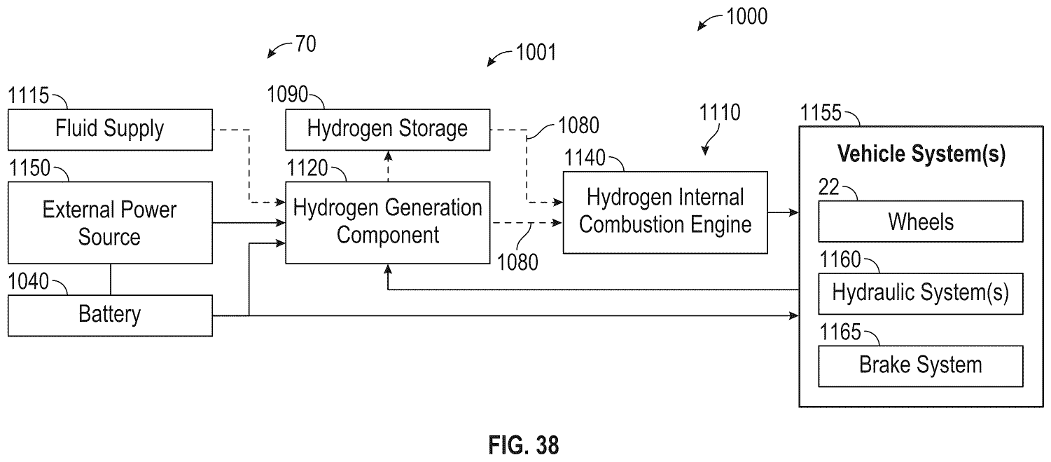

Referring still to FIG. 36, the fluid supply 1115 is fluidly coupled to the hydrogen generation component 1120 and configured to supply (e.g., via a supply conduit) the fluid to the hydrogen generation component 1120. As shown in FIG. 36 (and FIGS. 37 and 38), the dashed arrows between components represent a flow of fluid (e.g., a flow of the hydrogen donor compound fluid, a flow of the hydrogen, etc.). The hydrogen generation component 1120 is configured to generate (e.g., produce, separate, isolate, etc.) hydrogen (e.g., hydrogen gas or hydrogen liquid) as an output (e.g., a product of a chemical reaction) by separating the hydrogen molecules and/or atoms from the other molecules and/or atoms included in the fluid.

In some embodiments, the hydrogen generation component 1120 is an electrolyzer (e.g., an alkaline electrolyzer, a solid oxide electrolyzer, etc.) configured to perform an electrolysis process to generate hydrogen. In such embodiments, the fluid input or otherwise supplied (e.g., as a reactant of a chemical reaction) to the hydrogen generation component 1120 from the fluid supply 1115 includes water. The hydrogen generation component 1120 is configured to receive electrical energy and use the electrical energy to perform (e.g., start, initiate, induce, complete, etc.) the electrolysis process to generate the hydrogen. As will be discussed in greater detail below, the electrical energy used by the hydrogen generation component 1120 may be received by one or more batteries (e.g., the battery pack 1040), an external power source (e.g., external power source 1150, a power grid, power lines, an external charger, etc.), a brake system (e.g., brake system 1165) of the refuse vehicle 1000, and/or via an energy clipping process.

In some embodiments, the hydrogen generation component 1120 is a reactor (e.g., a reformer) configured to perform a natural gas hydrogen generation process such as hydrocarbon reforming (e.g., methane-steam reforming, partial oxidation, etc.), hydrocarbon/methane pyrolysis, or the like to generate hydrogen. In such embodiments, the fluid input or otherwise supplied (e.g., as a reactant of a chemical reaction) to the hydrogen generation component 1120 from the fluid supply 1115 includes methane. In some embodiments, the fluid input or otherwise supplied to the hydrogen generation component 1120 from the fluid supply 1115 includes both water and methane. In other embodiments, the fluid includes another suitable hydrocarbon or combination thereof (e.g., natural gas, propane, butane, ethane, pentane, etc.). The hydrogen generation component 1120 is configured to receive electrical energy and use the electrical energy to perform (e.g., start, initiate, induce, complete, provide heat, provide a spark/ignition, etc.) the natural gas hydrogen generation process to generate the hydrogen. As will be discussed in greater detail below, the electrical energy used by the hydrogen generation component 1120 may be received by one or more batteries (e.g., the battery pack 1040), an external power source (e.g., external power source 1150, a power grid, power lines, an external charger, etc.), a brake system (e.g., brake system 1165) of the refuse vehicle 1000, and/or via an energy clipping process.

After the hydrogen generation component 1120 generates (e.g., produces, separates, isolates, etc.) the hydrogen (e.g., hydrogen gas or hydrogen liquid) as an output (e.g., a product of a chemical reaction), the hydrogen generation component 1120 is configured to supply, via the fuel line 1080, the hydrogen to at least one of (i) the hydrogen storage 1090 or (ii) the power system 1110. The hydrogen may be stored by the hydrogen storage 1090 for use (e.g., as fuel) at a later time. By way of example, if the driving operations and the body operations being performed and powered by the power system 1110 without the need for additional hydrogen (e.g., a volume of hydrogen greater than what is needed to perform the driving and body operations), any excess hydrogen generated by the hydrogen generation component 1120 may be stored by the hydrogen storage 1090. In some embodiments, the generation system 70 does not include the hydrogen storage 1090. In such embodiments, the hydrogen generated by the hydrogen generation component 1120 is supplied directly to the power system 1110.

Referring still to FIG. 36, the power system 1110 includes at least one of (i) the fuel cell 18 or (ii) a hydrogen internal combustion engine (H-ICE), shown as hydrogen engine 1140. The fuel cell 18 and the hydrogen engine 1140 are configured to receive the hydrogen generated by the hydrogen generation component 1120 and consume the hydrogen as fuel to perform at least one of a driving operation or a body operation of the refuse vehicle 1000 (e.g., control one or more components of the refuse vehicle 1000). The driving operation may include providing power to drive one or more of the wheels 22 to propel the refuse vehicle 1000. In some embodiments, the driving operation includes providing power to a brake system (e.g., brake system 1165) to brake, slow, or stop the refuse vehicle 1000. In some embodiments, the driving operation includes providing power to one or more other components of the refuse vehicle 1000 associated with driving the refuse vehicle 1000 (e.g., powering a steering system, powering a user interface, powering a suspension system, powering one or more safety systems, etc.). The body operation may include providing power to operate one or more hydraulic systems of the refuse vehicle 1000 such as operating the tailgate 34, operating the lift assembly 42, operating the ejector 61, or providing power to one or more other components of the refuse vehicle 1000 associated with refuse collection and dumping operations.

In some embodiments, the fuel cell 18 and the hydrogen engine 1140 operate cooperatively with each other to provide energy to perform the driving operation and/or body operation of the refuse vehicle 1000. In other embodiments, the power system 1110 includes either the fuel cell 18 or the hydrogen engine 1140. In some embodiments, the fuel cell 18 and/or the hydrogen engine 1140 are configured to operate cooperatively with one or more power systems of the refuse vehicle 1000 (e.g., the prime mover 21, the battery pack 1040, the electric motor 57, the hydraulic pump 58, etc.) to power one or more components of the refuse vehicle 1000.

The fuel cell 18 is configured to receive the hydrogen generated by the hydrogen generation component 1120 and consume the hydrogen as fuel. The fuel cell 18 performs an electrochemical reaction that generates water (e.g., water vapor) as an output (e.g., product, exhaust, etc.). The fuel cell 18 generates and provides electrical energy to one or more components of the refuse vehicle 1000. The fuel cell 18 is configured to perform at least one of the driving operation or the body operation. In some embodiments, the fuel cell 18 is electrically coupled with the battery pack 1040 and configured to charge the battery pack 1040. In some embodiments, the refuse vehicle 1000 omits the prime mover 21 and/or the electric motor 57 (e.g., in embodiments in which the refuse vehicle 1000 is an electric refuse vehicle) and is replaced by the fuel cell 18. In other embodiments, the refuse vehicle 1000 is a hybrid refuse vehicle in which the fuel cell 18 is included with (e.g., operates cooperatively with) the prime mover 21 and/or the electric motor 57.

The hydrogen engine 1140 is configured to receive the hydrogen generated by the hydrogen generation component 1120 and consume the hydrogen as fuel. By way of example, the hydrogen engine 1140 mixes the hydrogen with air, compresses the hydrogen-air mixture, and combusts the hydrogen-air mixture causing an expansion. The reaction produces water (e.g., water vapor) as an output (e.g., product, exhaust, etc.). The hydrogen engine 1140 generates and provides electrical energy to one or more components of the refuse vehicle 1000. The hydrogen engine 1140 is configured to perform at least one of the driving operation or the body operation. In some embodiments, the hydrogen engine 1140 is electrically coupled with the battery pack 1040 and configured to charge the battery pack 1040. In some embodiments, the refuse vehicle 1000 omits the prime mover 21 and/or the electric motor 57 (e.g., in embodiments in which the refuse vehicle 1000 is an electric refuse vehicle) and is replaced by the hydrogen engine 1140. In other embodiments, the refuse vehicle 1000 is a hybrid refuse vehicle in which the hydrogen engine 1140 is included with (e.g., operates cooperatively with) the prime mover 21 and/or the electric motor 57.

In some embodiments, the water produced as an output of the fuel cell 18 and/or the hydrogen engine 1140 is captured and stored to be used for other applications instead of expelling to the atmosphere or on the ground as waste. In some embodiments, the captured water is filtered and recirculated back to the fluid supply 1115 for storage. In some embodiments, the electric motors of the refuse vehicle 1000 consume power from one or more other fuel cells to provide power to the systems of the refuse vehicle 1000. In such embodiments, the water, as a byproduct of the fuel cells, can be similarly captured and stored.

Referring now to FIGS. 37 and 38, the hydrogen system 1001 is shown fluidly and/or electrically coupled to a battery 1040 (e.g., battery pack 1040), an external power source 1150 (e.g., a power grid, power lines, an external charger, etc.), and one or more vehicle systems or components, shown as vehicle systems 1155. As shown in FIGS. 37 and 38, the dashed arrows between components (e.g., between the fluid supply 1115 and the hydrogen generation component 1120, etc.) represent a flow of fluid (e.g., a flow of the hydrogen donor compound fluid, a flow of the hydrogen, etc.). The solid lines between components (e.g., between the external power source 1150 and the hydrogen generation component 1120, between the power system 1110 (the fuel cell 18 and the hydrogen engine 1140) and the vehicle systems 1155, etc.) represent a flow of energy (e.g., electric energy, hydraulic energy, etc.).

The battery 1040 is configured to provide power to the hydrogen generation component 1120 to perform the hydrogen generation process to generate hydrogen. The battery 1040 may further provide power operate the vehicle systems 1155. The battery 1040 is configured to selectively coupled with the external power source 1150 (e.g., during charging operations) to receive energy therefrom, thereby charging the battery 1040. The external power source 1150 is configured to selectively couple with the hydrogen generation component 1120 to provide power directly thereto to perform the hydrogen generation process to generate hydrogen. In some embodiments, during charging operations (e.g., when the battery 1040 is being charged by the external power source 1150) when the battery 1040 has reached or is approaching charging capacity, the external power source 1150 directs power to the hydrogen generation component 1120. In other words, the hydrogen generation component 1120 can use excess energy received from the external power source 1150 when the battery 1040 has reached or is approaching charging capacity (e.g., no longer capable of receiving energy to charge the battery 1040). In some embodiments, the external power source 1150 simultaneously directs power to each of (i) the hydrogen generation component 1120 (e.g., to perform the hydrogen generation process to generate hydrogen) and (ii) the battery 1040 (e.g., to charge the battery 1040).

The vehicle systems 1155 include the wheels 22, one or more hydraulic systems 1160 of the refuse vehicle 1000, and a brake system 1165. In some embodiments, the vehicle systems 1155 include one or more other systems and components of the refuse vehicle 1000 capable of receiving power or electrical energy (e.g., a steering system, a user interface, a suspension system, one or more safety systems, a lighting system, etc.). As shown in FIG. 37, the power system 1110 is configured as the fuel cell 18 configured to provide power to the vehicle systems 1155. As shown in FIG. 38, the power system 1110 is configured as the hydrogen engine 1140 configured to provide power to the vehicle systems 1155.

The hydraulic systems 1160 may include one or more hydraulically (or pneumatically) powered actuators configured to actuate the tailgate 34, the lift assembly 42, the ejector 61, and/or to one or more other components of the refuse vehicle 1000 associated with refuse collection and dumping operations. In some embodiments, the vehicle systems 1155, and the hydraulic systems 1160 included therein, are electrically coupled with, and configured to provide power to the hydrogen generation component 1120 to perform the hydrogen generation process to generate hydrogen. By way of example, the hydraulic systems 1160 may include one or more energy storage devices, such as hydraulic storage devices and/or capacitors. The hydraulic storage devices may be configured to store a pressurized fluid. When the hydraulic storage device releases some or all of the pressurized fluid, the fluid flow may be converted to another type of energy (e.g., electrical energy). According to various embodiments, the hydraulic storage devices may be in fluid communication with the hydraulic systems 1160. Further, the energy storage devices may include one or more capacitors that enable energy clipping. For example, if a motor or hydraulic storage device outputs more energy than is needed by the refuse vehicle 1000, the capacitor may store that energy for use at a later time and/or provide that energy to the hydrogen generation component 1120.

The brake system 1165 may be coupled with one or more of the wheels 22 to brake, slow, or stop the refuse vehicle 1000. In some embodiments, the vehicle systems 1155, and the brake system 1165 included therein, are electrically coupled with and configured to provide power to the hydrogen generation component 1120 to perform the hydrogen generation process to generate hydrogen. By way of example, the brake system 1165 may be a regenerative braking system including a motor, generator, alternator, or the like configured to convert kinetic energy during braking into electrical energy. The electrical energy may then be used to power the hydrogen generation component 1120.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body defining a refuse compartment, the body coupled to the chassis;
a fuel tank coupled to the body;
a battery coupled to the body;
a hydrogen fuel cell coupled to the chassis;
a battery cable coupling the battery to the hydrogen fuel cell; and
a fuel conduit coupling the fuel tank to the hydrogen fuel cell.

2. The refuse vehicle of claim 1, wherein each of the battery cable and the fuel conduit define an inflexible section of tubing extending along the body and a flexible section of tubing extending between the body and the chassis.

3. The refuse vehicle of claim 1, wherein the battery cable includes a flexible section of tubing, and the body further comprises:
a body terminal defined by the body, the body terminal configured to couple to a first end of the flexible section of tubing; and
a chassis terminal defined by the chassis, the chassis terminal configured to couple to a second end of the flexible section of tubing, wherein the flexible section of tubing couples the body terminal to the chassis terminal.

4. The refuse vehicle of claim 3, wherein the battery cable includes an inflexible section of tubing, the inflexible section of tubing couples the battery to the body terminal, the body terminal coupled to one or more electrical components of the body, and the chassis terminal coupled to one or more electrical components of the chassis.

5. The refuse vehicle of claim 3, wherein the fuel conduit includes a second flexible section of tubing, and the body further comprises:
a second body terminal defined by the body, the second body terminal configured to couple to a first end of a second flexible section of tubing; and
a second chassis terminal defined by the chassis, the second chassis terminal configured to couple to a second end of a second flexible section of tubing, wherein the second flexible section of tubing couples the second body terminal to the second chassis terminal.

6. The refuse vehicle of claim 5, wherein the fuel conduit includes an inflexible section of tubing and the inflexible section of tubing connects the fuel tank to the second body terminal and the second chassis terminal to the hydrogen fuel cell.

7. The refuse vehicle of claim 1, wherein the fuel conduit includes a flexible section of tubing, and the body further comprises:
a body terminal defined by the body, the body terminal configured to couple to a first end of the flexible section of tubing; and
a chassis terminal defined by the chassis, the chassis terminal configured to couple to a second end of the flexible section of tubing, wherein the flexible section of tubing couples the body terminal to the chassis terminal.

8. The refuse vehicle of claim 1, wherein:
the fuel conduit includes a first inflexible section of tubing coupled to the fuel tank, the first inflexible section of tubing extending along a top of the body and down a first side of the body; and
the battery cable includes a second inflexible section of tubing, the second inflexible section of tubing extending along the top of the body and down a second side of the body, the second side of the body opposite the first side of the body.

9. The refuse vehicle of claim 1, further comprising:
a pivot assembly coupled to the chassis and the body; and
an actuator coupled to the body and the chassis, the actuator configured to lift and pivot the body relative to the chassis, wherein at least a portion of the battery cable and the fuel conduit are configured to flex at a first angle when the body is in a first position and flex at a second angle when the body is in a second position.

10. The refuse vehicle of claim 1, wherein at least a portion of each of the battery cable and the fuel conduit include a flexible section of tubing, the refuse vehicle further comprising:
a pivot assembly coupled to the chassis and the body;
a first chassis terminal defined by the chassis; and
a second chassis terminal defined by the chassis, wherein the body is configured to pivot relative to the chassis about a pivot of the pivot assembly and each of the flexible sections of tubing extend from the hydrogen fuel cell, wrap around the pivot, and extend to the first chassis terminal or the second chassis terminal.

11. The refuse vehicle of claim 1, wherein the battery cable includes a first inflexible section of tubing, the first inflexible section of tubing extending from the battery located at a rear top side of the body, the first inflexible section of tubing extending to a front top side of the body and down a front side of the body towards the chassis, wherein the fuel conduit includes a second inflexible section of tubing, the fuel tank located at a rear top side of the body next to the battery, the second inflexible section of tubing extending from the fuel tank to a front top side of the body and down the front side of the body towards the chassis.

12. A refuse vehicle comprising:
a chassis;
a body coupled to the chassis;
a fuel tank coupled to the body;
a battery coupled to the body;
a fuel conduit coupled to the fuel tank, the fuel conduit extending along a first side of the body; and
a battery cable coupled to the battery, the battery cable coupled to the battery and extending along a second side of the body, the second side of the body opposite the first side of the body.

13. The refuse vehicle of claim 12, further comprising:
an actuator coupled to the body and the chassis and configured to lift and pivot the body relative to the chassis;
a pivot assembly coupling the body to the chassis, the body configured to pivot relative to the chassis about a pivot of the pivot assembly;
a first chassis terminal defined by the chassis; and
a second chassis terminal defined by the chassis, wherein the fuel conduit extends from the fuel tank, wraps around the pivot, and extends to the first chassis terminal and the battery cable extends from the battery, wraps around the pivot, and extends to the second chassis terminal.

14. The refuse vehicle of claim 12, wherein the fuel conduit and the battery cable are contained within an inflexible tubing section mounted to a top of the body and the fuel conduit and the battery cable are comprised of inflexible tubing where the fuel conduit and the battery cable extend along the first side and the second side of the body.

15. The refuse vehicle of claim 12, further comprising:
a hydrogen fuel cell coupled to the chassis;
a body terminal defined by the body, the body terminal coupled to the fuel conduit; and
a chassis terminal defined by the chassis, the chassis terminal coupled to the fuel conduit, wherein the fuel conduit extends between the body terminal and the chassis terminal and between the chassis terminal and the hydrogen fuel cell, the fuel conduit configured to deliver hydrogen to the hydrogen fuel cell.

16. The refuse vehicle of claim 15, further comprising:
a hydrogen fuel cell coupled to the chassis;
a second body terminal defined by the body, the second body terminal coupled to the battery cable; and
a second chassis terminal defined by the chassis, the second chassis terminal coupled to the battery cable, wherein the battery cable extends between the second body terminal and the second chassis terminal and between the second chassis terminal and the hydrogen fuel cell, the battery cable configured to deliver electricity from the hydrogen fuel cell to the battery.

17. The refuse vehicle of claim 16, wherein:
the fuel conduit defines a 180-degree loop, a first end of the fuel conduit coupled to the chassis terminal and a second end of the fuel conduit coupled to the hydrogen fuel cell; and
the battery cable defines a 180-degree loop, a first end of the battery cable coupled to the second chassis terminal and a second end of the battery cable coupled to the hydrogen fuel cell.

18. The refuse vehicle of claim 12, wherein a portion of the battery cable is contained within a first chain housing and a portion of the fuel conduit is contained within a second chain housing, the first chain housing and the second chain housing configured to enable the portion of the battery cable and the portion of the fuel conduit to flex while resisting pinching.

19. The refuse vehicle of claim 12, wherein the battery and the fuel tank are located on top of a rear portion of the body.

20. A vehicle comprising:
a chassis;
a body coupled to the chassis;
a fuel tank coupled to the body;
a battery coupled to the body;
a hydrogen fuel cell coupled to the chassis;
a fuel conduit coupled to the fuel tank and the hydrogen fuel cell, the fuel conduit configured to deliver hydrogen from the fuel tank to the hydrogen fuel cell; and
a battery cable coupled to the battery and the hydrogen fuel cell, the battery cable configured to deliver electricity from the hydrogen fuel cell to the battery, wherein the fuel conduit extends along a first side of the body and the battery cable extends along a second side of the body, the first side of the body opposite the first side of the body.
